(19) United States
(12) Patent Application Publication
(10) Pub. No.: US 2026/0015560 A1
(43) Pub. Date: Jan. 15, 2026

(54) COMPOSITIONS FOR POST-CMP CLEANING OF MICROELECTRONIC DEVICES

(71) Applicant: ENTEGRIS, INC., Billerica, MA (US)

(72) Inventors: Michael L. White, Ridgefield, CT (US); Jun Liu, Newtown, CT (US); Atanu K. Das, Southbury, CT (US); Sudeep Pallikkara Kuttiatoor, Naperville, IL (US); Daniela White, Ridgefield, CT (US); Michael Owens, Ridgefield, CT (US); Satish Rai, Aurora, IL (US)

(21) Appl. No.: 19/262,294

(22) Filed: Jul. 8, 2025

Related U.S. Application Data
(60) Provisional application No. 63/669,125, filed on Jul. 9, 2024.

(51) Int. Cl. C11D 7/34; C11D 7/26; C11D 7/32; C11D 7/36; C11D 7/50

(52) U.S. Cl. CPC C11D 7/34; C11D 7/265; C11D 7/3209; C11D 7/3218; C11D 7/36; C11D 7/5022; C11D 2111/22; C11D 2111/40

(57) ABSTRACT

The invention provides a composition comprising (a) water, (b) a sulfonated polymer, a sulfonated alkyl amine compound, or a combination thereof, (c) a chelating agent, and (d) an organic compound comprising a quaternary amine, wherein the composition has a pH of less than about 7. The invention also provides a method for removing residue from a surface of a microelectronic device substrate comprising contacting the surface of the microelectronic device substrate with the compositions described herein.

### BACKGROUND OF THE INVENTION

Microelectronic device wafers are used to form integrated circuits and include a substrate, such as silicon, on which regions are patterned for deposition of different materials having insulative, conductive or semi-conductive properties. To obtain the correct patterning, excess material used in forming the layers on the substrate must be removed. Further, to fabricate functional and reliable circuitry, it is important to prepare a flat or planar microelectronic wafer surface prior to subsequent processing. Thus, it is necessary to remove and/or polish certain surfaces of a microelectronic device wafer.

Chemical Mechanical Polishing or Planarization (“CMP”) is a process in which material is physically and chemically removed from a surface of a microelectronic device wafer. The surface is polished (more specifically, planarized) by coupling a physical process such as abrasion with a chemical process such as oxidation or chelation. In its most rudimentary form, CMP involves applying slurry, e.g., a dispersion of an abrasive and an active chemistry, to a polishing pad that buffs the surface of a microelectronic device wafer to achieve the removal, planarization, and polishing processes. It is not desirable for the removal or polishing process to be comprised of purely physical or purely chemical action, but rather it is the synergistic combination of both that achieves fast, uniform removal.

Following CMP processing, particles, residue and other contaminants may be present on the surface of the microelectronic device. As a result, post-CMP removal compositions have been developed to remove the post-CMP residue (e.g., particles and contaminants), which may interfere with subsequent device processing steps. However, often these post-CMP removal compositions unintentionally at least partially remove other materials from the device surface that should remain.

For example, as semiconductor devices become more highly integrated and minute, tungsten and molybdenum films are receiving greater attention as a potential new metal electrode for next generation semiconductor devices. However, during typical post-CMP removal processes, removal compositions often remove unacceptable levels of tungsten and/or molybdenum from the surface as well, which can lead to the development of faults and pattern defects. This becomes a greater problem the higher the pH of the removal composition.

In relation to this, new additives are needed to inhibit tungsten and/or molybdenum corrosion (providing a lower etch rate and lower roughness) while post-CMP cleaning of dielectric substrates (PETEOS, SiO₂, thermal oxide, silicon nitride, silicon, etc.) are well-cleaned at the same time.

Thus, there remains a need in the art for new, useful, and improved cleaning compositions, and specific ingredients are continually sought, especially for use with new microelectronic device structures such as those that may now include surfaces comprising tungsten and/or molybdenum. The invention provides such cleaning compositions and uses. These and other advantages of the invention, as well as additional inventive features, will be apparent from the description of the invention provided herein.

### BRIEF SUMMARY OF THE INVENTION

The invention provides a composition comprising (a) water, (b) a sulfonated polymer, a sulfonated alkyl amine compound, or a combination thereof, (c) a chelating agent, and (d) an organic compound comprising a quaternary amine, wherein the composition has a pH of less than about 7.

The invention also provides a kit comprising (a) a sulfonated polymer, a sulfonated alkyl amine compound, or a combination thereof, (b) a chelating agent, and (c) an organic compound comprising a quaternary amine, as described herein.

The invention further provides a method for removing residue from a surface of a microelectronic device substrate, the method comprising (i) contacting the surface of the microelectronic device substrate with a composition comprising (a) water, (b) a sulfonated polymer, a sulfonated alkyl amine compound, or a combination thereof, (c) a chelating agent, and (d) an organic compound comprising a quaternary amine, wherein the composition has a pH of less than about 7, and (ii) removing at least a portion of the residue from the surface of the microelectronic device substrate.

### BRIEF DESCRIPTION OF THE DRAWINGS

FIG. 1 is a graph showing the molybdenum (Mo) etch rate (Å/min) exhibited by Cleaning Compositions 1A-1G of Example 1.

FIG. 2 is a graph showing the slurry particle removal, as measured by the remaining particle surface area (Å²), exhibited by Cleaning Compositions 1A-1G of Example 1.

FIG. 3 is a graph showing the MoO₃ turbidity (NTU) exhibited by Cleaning Compositions 1A-1G of Example 1.

FIG. 4 is a graph showing the dissolved iron (ppb) results, as measured by inductively coupled plasma spectroscopy, exhibited by Cleaning Compositions 1A-1G of Example 1.

FIG. 5 is a graph showing the dissolved molybdenum (ppb), as measured by inductively coupled plasma spectroscopy, exhibited by Cleaning Compositions 1A-1G of Example 1.

FIG. 6 is a graph showing the Tafel open circuit potential (OCP) (V vs. Ag/AgCl) exhibited by Cleaning Compositions 1A-1G, as described in Example 2.

FIG. 7 is a graph showing the molybdenum (Mo) etch rate (Å/min) exhibited by Cleaning Compositions 2A-2D of Example 3.

FIG. 8 is a graph showing the total surface defects at 65 nm on molybdenum (Mo), silicon oxide (TEOS), and silicon nitride (Si₃N₄) exhibited by Cleaning Compositions 2A-2D of Example 3.

### DETAILED DESCRIPTION OF THE INVENTION

The invention provides a composition comprising (a) water, (b) a sulfonated polymer, a sulfonated alkyl amine compound, or a combination thereof, (c) a chelating agent, and (d) an organic compound comprising a quaternary amine, wherein the composition has a pH of less than about 7.

The composition comprises water as a liquid carrier, i.e., a solute, of the non-aqueous components (e.g., the cleaning agent, the chelating agent, the pH adjustor, and other optional components). The water can be any suitable water and can be, for example, deionized water (DIW) or distilled water. Water can be present in the composition from any source, such as by being contained in a component that is combined with other components to produce a composition in the form of a concentrate; as water combined in pure form to other components of a concentrate; or as water added to a concentrate, e.g., at a point of use, as dilution water for the purpose of diluting a concentrate to a desirable concentration for use.

The composition can comprise any suitable amount of water. For example, the amount of water can be a particular amount for preparing a concentrate, or a particular amount to provide a desirable concentration for use, which concentration for use is generally a higher amount relative to the amount of water in a concentrate. In some embodiments, the composition exists as a concentrate and comprises from about 5 wt. % to about 90 wt. % water, based on the total weight of the composition, for example, from about 10 wt. % to about 90 wt. %, from about 20 wt. % to about 90 wt. %, from about 30 wt. % to about 90 wt. %, from about 40 wt. % to about 90 wt. %, from about 50 wt. % to about 90 wt. %, from about 60 wt. % to about 90 wt. %, from about 70 wt. % to about 90 wt. %, from about 5 wt. % to about 80 wt. %, from about 10 wt. % to about 80 wt. %, from about 20 wt. % to about 80 wt. %, from about 30 wt. % to about 80 wt. %, from about 40 wt. % to about 80 wt. %, from about 50 wt. % to about 80 wt. %, from about 60 wt. % to about 80 wt. %, or from about 70 wt. % to about 80 wt. % water based on the total weight of the composition.

Upon dilution, the amount of water in the composition will be increased, such that, in embodiments, the diluted composition comprises from about 70 wt. % to about 99.99 wt. % water, based on the total weight of the composition, for example, from about 70 wt. % to about 99.9 wt. %, from about 70 wt. % to about 99.5 wt. %, from about 70 wt. % to about 99 wt. %, from about 70 wt. % to about 98 wt. %, from about 70 wt. % to about 95 wt. %, from about 80 wt. % to about 99.99 wt. %, from about 80 wt. % to about 99.9 wt. %, from about 80 wt. % to about 99.5 wt. %, from about 80 wt. % to about 99 wt. %, from about 80 wt. % to about 98 wt. %, from about 80 wt. % to about 95 wt. %, from about 90 wt. % to about 99.99 wt. %, from about 90 wt. % to about 99.9 wt. %, from about 90 wt. % to about 99.5 wt. %, from about 90 wt. % to about 99 wt. %, from about 90 wt. % to about 98 wt. %, from about 90 wt. % to about 95 wt. %, from about 95 wt. % to about 99.99 wt. %, from about 95 wt. % to about 99.9 wt. %, from about 95 wt. % to about 99.5 wt. %, from about 95 wt. % to about 99 wt. %, or from about 95 wt. % to about 98 wt. % water based on the total weight of the composition. In some embodiments, the diluted composition comprises from about 70 wt. % to about 99.9 wt. % water.

The composition comprises a sulfonated polymer, a sulfonated alkyl amine compound, or a combination thereof. In other words, the composition comprises (i) a sulfonated polymer but not a sulfonated alkyl amine compound, (ii) a sulfonated alkyl amine compound but not a sulfonated polymer, or (iii) a sulfonated polymer and a sulfonated alkyl amine compound. In some embodiments, the composition comprises a sulfonated polymer. In some embodiments, the composition comprises a sulfonated alkyl amine compound. In certain embodiments, the composition comprises a sulfonated polymer and a sulfonated alkyl amine compound.

In some embodiments, the composition comprises a sulfonated alkyl amine compound. The sulfonated alkyl amine compound can be any suitable compound comprising an alkyl amine moiety and a sulfonate (e.g., a sulfonic acid) moiety. In some embodiments, the sulfonated alkyl amine compound further comprises a hydroxyl moiety. The sulfonated alkyl amine compound can have any suitable molecular weight. For example, the organic compound comprising a quaternary amine can have a molecular weight of about 125 g/mol to about 1000 g/mol, e.g., about 125 g/mol to about 500 g/mol, 125 g/mol to about 400 g/mol, about 125 g/mol to about 300 g/mol, about 150 g/mol to about 1000 g/mol, e.g., about 150 g/mol to about 500 g/mol, 150 g/mol to about 400 g/mol, about 150 g/mol to about 300 g/mol, about 200 g/mol to about 1000 g/mol, e.g., about 200 g/mol to about 500 g/mol, 200 g/mol to about 400 g/mol, or about 200 g/mol to about 300 g/mol. In some embodiments, the sulfonated alkyl amine compound has a molecular weight of about 200 g/mol to about 500 g/mol. In certain embodiments, the sulfonated alkyl amine compound has a molecular weight of about 200 g/mol to about 300 g/mol. Exemplary sulfonated alkyl amine compounds include, but are not limited to, 4-(2-hydroxyethyl)-1-piperazineethane sulfonic acid (HEPES) and [tris(hydroxymethyl)methylamino]propane sulfonic acid (TAPS).

The composition can comprise any suitable amount of the sulfonated alkyl amine compound. The amount of the sulfonated alkyl amine compound refers to the total amount of sulfonated alkyl amine compound present in the composition. The composition can comprise about 0.001 wt. % or more of the sulfonated alkyl amine compound based on the total weight of the composition, for example, about 0.005 wt. % or more, about 0.01 wt. % or more, 0.05 wt. % or more, about 0.1 wt. % or more, about 0.2 wt. % or more, about 0.3 wt. % or more, about 0.4 wt. % or more, about 0.5 wt. % or more, or about 1 wt. % or more of the sulfonated alkyl amine compound based on the total weight of the composition. Alternatively, or in addition, the composition can comprise 20 wt. % or less of the sulfonated alkyl amine compound based on the total weight of the composition, for example, about 10 wt. % or less, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the sulfonated alkyl amine compound based on the total weight of the composition. Thus, the composition can comprise the sulfonated alkyl amine compound in an amount bounded by any two of the aforementioned endpoints.

For example, the composition can comprise about 0.001 wt. % to about 20 wt. % of the sulfonated alkyl amine compound based on the total weight of the composition, e.g., about 0.001 wt. % to about 10 wt. %, about 0.001 wt. % to about 8 wt. %, about 0.001 wt. % to about 6 wt. %, about 0.001 wt. % to about 5 wt. %, about 0.001 wt. % to about 4 wt. %, about 0.001 wt. % to about 2 wt. %, about 0.001 wt. % to about 1 wt. %, about 0.001 wt. % to about 0.05 wt. %, about 0.005 wt. % to about 20 wt. %, about 0.005 wt. % to about 10 wt. %, about 0.005 wt. % to about 8 wt. %, about 0.005 wt. % to about 6 wt. %, about 0.005 wt. % to about 5 wt. %, about 0.005 wt. % to about 4 wt. %, about 0.005 wt. % to about 2 wt. %, about 0.005 wt. % to about 1 wt. %, about 0.005 wt. % to about 0.05 wt. %, about 0.05 wt. % to about 20 wt. %, about 0.05 wt. % to about 10 wt. %, about 0.05 wt. % to about 8 wt. %, about 0.05 wt. % to about 6 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.5 wt. % to about 20 wt. %, about 0.5 wt. % to about 10 wt. %, about 0.5 wt. % to about 8 wt. %, about 0.5 wt. % to about 6 wt. %, about 0.5 wt. % to about 5 wt. %, about 0.5 wt. % to about 4 wt. %, about 0.5 wt. % to about 2 wt. %, or about 0.5 wt. % to about 1 wt. % of the sulfonated alkyl amine compound based on the total weight of the composition. In some embodiments, the composition comprises about 0.1 wt. % to about 5 wt. % of the sulfonated alkyl amine compound based on the total weight of the composition. In certain embodiments, the composition comprises about 0.1 wt. % to about 2 wt. % of the sulfonated alkyl amine compound based on the total weight of the composition.

In some embodiments, the composition comprises a sulfonated polymer (e.g., a homopolymer or a copolymer). The sulfonated polymer can be any suitable polymer comprising a sulfonic acid monomeric unit. The sulfonic acid monomer unit can be any suitable sulfonic acid monomer unit comprising one or more groups of the formula: —SO₃H. Exemplary sulfonic acid monomer units include, but are not limited to, vinyl sulfonic acid, styrene sulfonic acid (e.g., 4-styrene sulfonic acid), allylsulfonic acid, ethylacrylate sulfonic acid, butyl acrylate sulfonic acid, isoprene sulfonic acid, 2-acrylamido-2-methyl-1-propanesulfonic acid, 2-methylacrylamido-2-methylpropane sulfonic acid, 3-allyloxy-2-hydroxy-1-propanesulfonic acid, 2-sulfoethyl methacrylate, 2-sulfoethylacrylate, 3-sulfopropyl methacrylate, 3-sulfopropyl acrylate, and salts thereof. In some embodiments, the sulfonated polymer comprises a monomer unit derived from a monomer selected from 2-acrylamido-2-methylpropane sulfonic acid, 2-methylacrylamido-2-methylpropane sulfonic acid, styrene sulfonic acid, vinyl sulfonic acid, 3-allyloxy-2-hydroxy-1-propanesulfonic acid, 2-sulfoethyl methacrylate, 2-sulfoethylacrylate, 3-sulfopropyl methacrylate, 3-sulfopropyl acrylate, salts thereof, and combinations thereof. In certain embodiments, the sulfonated polymer (e.g., homopolymer or copolymer) comprises a monomer unit derived from a monomer selected from 2-acrylamido-2-methylpropane sulfonic acid, styrene sulfonic acid, salts thereof, and combinations thereof. The polymer comprising a sulfonic acid monomeric unit can be provided in its free acid form, as a salt thereof, or as a partial salt thereof.

In some embodiments, the sulfonated polymer is a homopolymer selected from poly-2-acrylamido-2-methylpropane sulfonic acid, poly-2-methylacrylamido-2-methylpropane sulfonic acid, polystyrene sulfonic acid (e.g., poly-4-styrene sulfonic acid), polyvinyl sulfonic acid, poly-3-allyloxy-2-hydroxy-1-propanesulfonic acid, poly-2-sulfoethyl methacrylate, poly-2-sulfoethylacrylate, poly-3-sulfopropyl methacrylate, poly-3-sulfopropyl acrylate, and salts thereof. In other embodiments, the sulfonated polymer is a copolymer comprising a monomer unit derived from a monomer selected from 2-acrylamido-2-methylpropane sulfonic acid, 2-methylacrylamido-2-methylpropane sulfonic acid, styrene sulfonic acid, vinyl sulfonic acid, 3-allyloxy-2-hydroxy-1-propanesulfonic acid, 2-sulfoethyl methacrylate, 2-sulfoethylacrylate, 3-sulfopropyl methacrylate, 3-sulfopropyl acrylate, salts thereof and one or more additional monomer units. The one or more additional monomer units can be any suitable monomer unit capable of polymerization with the sulfonic acid monomeric unit. In some embodiments, the sulfonated polymer further comprises one or more additional monomer units derived from a (meth)acrylate monomer, a (meth)acrylamido monomer, a styrenic monomer, a vinylic monomer, or a combination thereof. Exemplary additional monomer units include, but are not limited to, (meth)acrylic acid (i.e., methacrylic acid or acryl acid), (meth)acrylamide (i.e., methacrylamide or acrylamide), hydroxypropylacrylate, tertiary butyl acrylamide, ethylene, propylene, isoprene, and styrene.

In embodiments where the sulfonated polymer is a copolymer, the copolymer can be any suitable copolymer. For example, the copolymer can be a random copolymer, a block copolymer, a graft copolymer, or an alternating copolymer.

In certain embodiments, the sulfonated polymer comprises a monomer unit derived from styrene sulfonic acid (e.g., 4-styrene sulfonic acid) or a salt thereof. In a preferred embodiment, the sulfonated polymer is polystyrene sulfonic acid or a salt thereof.

The sulfonated polymer can have any suitable weight average molecular weight. The sulfonated polymer can have a weight average molecular weight of about 50,000 g/mol or more, for example, about 55,000 g/mol or more, about 60,000 g/mol or more, about 65,000 g/mol or more, about 70,000 g/mol or more, about 75,0000 g/mol or more, about 80,000 g/mol or more, about 85,000 g/mol or more, about 90,000 g/mol or more, about 95,000 g/mol or more, about 100,000 g/mol or more, about 110,000 g/mol or more, about 120,000 g/mol or more, about 130,000 g/mol or more, about 140,000 g/mol or more, or about 150,000 g/mol or more. Alternatively, or in addition, the sulfonated polymer can have a weight average molecular weight of about 200,000 g/mol or less, for example, about 195,000 g/mol or less, about 190,000 g/mol or less, about 185,000 g/mol or less, about 180,000 g/mol or less, about 175,000 g/mol or less, about 170,000 g/mol or less, about 165,000 g/mol or less, about 160,000 g/mol or less, about 155,000 g/mol or less, or about 150,000 g/mol or less.

Thus, the sulfonated polymer can have a weight average molecular weight bounded by any two of the aforementioned endpoints. For example, the sulfonated polymer can have a weight average molecular weight of about 50,000 g/mol to about 200,000 g/mol, about 60,000 g/mol to about 200,000 g/mol, about 70,000 g/mol to about 200,000 g/mol, about 75,000 g/mol to about 200,000 g/mol, about 80,000 g/mol to about 200,000 g/mol, about 90,000 g/mol to about 200,000 g/mol, about 100,000 g/mol to about 200,000 g/mol, about 50,000 g/mol to about 190,000 g/mol, about 50,000 g/mol to about 180,000 g/mol, about 50,000 g/mol to about 170,000 g/mol, about 50,000 g/mol to about 160,000 g/mol, about 50,000 g/mol to about 150,000 g/mol, or about 75,000 g/mol to about 150,000 g/mol.

In certain embodiments, the sulfonated polymer has a weight average molecular weight of about 200,000 g/mol or less (e.g., about 50,000 g/mol to about 200,000 g/mol).

The composition can comprise any suitable amount of the sulfonated polymer. The amount of the sulfonated polymer refers to the total amount of sulfonic acid polymer or copolymer present in the composition. The composition can comprise about 0.001 wt. % or more of the sulfonated polymer based on the total weight of the composition, for example, about 0.005 wt. % or more, about 0.01 wt. % or more, 0.05 wt. % or more, about 0.1 wt. % or more, about 0.2 wt. % or more, about 0.3 wt. % or more, about 0.4 wt. % or more, about 0.5 wt. % or more, or about 1 wt. % or more of the sulfonated polymer based on the total weight of the composition. Alternatively, or in addition, the composition can comprise 20 wt. % or less of the sulfonated polymer based on the total weight of the composition, for example, about 10 wt. % or less, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the sulfonated polymer based on the total weight of the composition. Thus, the composition can comprise the sulfonated polymer in an amount bounded by any two of the aforementioned endpoints.

For example, the composition can comprise about 0.001 wt. % to about 20 wt. % of the sulfonated polymer based on the total weight of the composition, e.g., about 0.001 wt. % to about 10 wt. %, about 0.001 wt. % to about 8 wt. %, about 0.001 wt. % to about 6 wt. %, about 0.001 wt. % to about 5 wt. %, about 0.001 wt. % to about 4 wt. %, about 0.001 wt. % to about 2 wt. %, about 0.001 wt. % to about 1 wt. %, about 0.001 wt. % to about 0.05 wt. %, about 0.005 wt. % to about 20 wt. %, about 0.005 wt. % to about 10 wt. %, about 0.005 wt. % to about 8 wt. %, about 0.005 wt. % to about 6 wt. %, about 0.005 wt. % to about 5 wt. %, about 0.005 wt. % to about 4 wt. %, about 0.005 wt. % to about 2 wt. %, about 0.005 wt. % to about 1 wt. %, about 0.005 wt. % to about 0.05 wt. %, about 0.05 wt. % to about 20 wt. %, about 0.05 wt. % to about 10 wt. %, about 0.05 wt. % to about 8 wt. %, about 0.05 wt. % to about 6 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.5 wt. % to about 20 wt. %, about 0.5 wt. % to about 10 wt. %, about 0.5 wt. % to about 8 wt. %, about 0.5 wt. % to about 6 wt. %, about 0.5 wt. % to about 5 wt. %, about 0.5 wt. % to about 4 wt. %, about 0.5 wt. % to about 2 wt. %, or about 0.5 wt. % to about 1 wt. % of the sulfonated polymer based on the total weight of the composition. In some embodiments, the composition comprises about 0.1 wt. % to about 5 wt. % of the sulfonated polymer based on the total weight of the composition. In certain embodiments, the composition comprises about 0.1 wt. % to about 2 wt. % of the sulfonated polymer based on the total weight of the composition.

The composition comprises a chelating agent. The chelating agent can be any suitable compound capable of chelating one or more metals (e.g., iron, copper, etc.). In some embodiments, the chelating agent is selected from ethylenediamine tetraacetic acid (EDTA), hydroxyethylethylenediamine triacetic (HEDTA), cyclohexane diamine tetraacetic acid (CDTA), and diethylenetriamine pentaacetic acid (DETPA), hydroxyethylidene diphosphonic acid (HEDP), diethylenetriamine pentamethylene phosphonic acid, bis (hexamethylene) triaminepenta (methylenephosphonic) acid, nitrilotri(methylphosphonic acid), hexamethylenediamine-N,N,N′,N′-tetrakis (methylphosphonic acid), 2-phosphono-1,2,4-butane carboxylic acid, citric acid, ascorbic acid, picolinic acid, dipicolinic acid, salts thereof, and combinations thereof. In certain embodiments, the chelating agent is selected from hydroxyethylidene diphosphonic acid (HEDP), nitrilotri(methylphosphonic acid), citric acid, picolinic acid, dipicolinic acid, salts thereof, and combinations thereof.

The composition can comprise any suitable amount of the chelating agent. The composition can comprise about 20 wt. % or less of the chelating agent based on the total weight of the composition, for example, about 10 wt. % or less, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the chelating agent based on the total weight of the composition. Alternatively, or in addition, the composition can comprise about 0.001 wt. % or more of the chelating agent based on the total weight of the composition, for example, about 0.005 wt. % or more, about 0.01 wt. % or more, 0.05 wt. % or more, about 0.1 wt. % or more, about 0.2 wt. % or more, about 0.3 wt. % or more, about 0.4 wt. % or more, about 0.5 wt. % or more, or about 1 wt. % or more of the chelating agent based on the total weight of the composition. Thus, the composition can comprise the chelating agent in any amount bounded by any two of the aforementioned endpoints, as appropriate.

For example, in some embodiments, the chelating agent can be present in the composition in an amount of about 0.001 wt. % to about 20 wt. % based on the total weight of the composition, e.g., about 0.001 wt. % to about 10 wt. %, about 0.001 wt. % to about 8 wt. %, about 0.001 wt. % to about 6 wt. %, about 0.001 wt. % to about 5 wt. %, about 0.001 wt. % to about 4 wt. %, about 0.001 wt. % to about 2 wt. %, about 0.001 wt. % to about 1 wt. %, about 0.001 wt. % to about 0.05 wt. %, about 0.05 wt. % to about 20 wt. %, about 0.005 wt. % to about 20 wt. %, about 0.005 wt. % to about 10 wt. %, about 0.005 wt. % to about 8 wt. %, about 0.005 wt. % to about 6 wt. %, about 0.005 wt. % to about 5 wt. %, about 0.005 wt. % to about 4 wt. %, about 0.005 wt. % to about 2 wt. %, about 0.005 wt. % to about 1 wt. %, about 0.005 wt. % to about 0.05 wt. %, about 0.05 wt. % to about 20 wt. %, about 0.05 wt. % to about 10 wt. %, about 0.05 wt. % to about 8 wt. %, about 0.05 wt. % to about 6 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.5 wt. % to about 20 wt. %, about 0.5 wt. % to about 10 wt. %, about 0.5 wt. % to about 8 wt. %, about 0.5 wt. % to about 6 wt. %, about 0.5 wt. % to about 5 wt. %, about 0.5 wt. % to about 4 wt. %, about 0.5 wt. % to about 2 wt. %, or about 0.5 wt. % to about 1 wt. % of the chelating agent based on the total weight of the composition. In some embodiments, the composition comprises about 1 wt. % to about 20 wt. % of the chelating agent based on the total weight of the composition. In certain embodiments, the composition comprises about 1 wt. % to about 10 wt. % of the chelating agent based on the total weight of the composition.

The composition comprises an organic compound comprising a quaternary amine. The organic compound comprising a quaternary amine can be any suitable compound comprising a quaternary amine (e.g., an ammonium). The organic compound comprising a quaternary amine can have any suitable molecular weight. For example, the organic compound comprising a quaternary amine can have a molecular weight of about 50 g/mol to about 500 g/mol, e.g., about 50 g/mol to about 400 g/mol, about 50 g/mol to about 300 g/mol, about 50 g/mol to about 200 g/mol, about 100 g/mol to about 500 g/mol, about 100 g/mol to about 400 g/mol, about 100 g/mol to about 300 g/mol, or about 100 g/mol to about 200 g/mol.

In some embodiments, the organic compound comprising a quaternary amine is selected from dimethyldiethylammonium hydroxide, dimethyldiethylammonium chloride, dimethyldiethylammonium bromide, dimethyldiethylammonium sulfate, dimethyldiethylammonium methanesulfonate, dimethyldiethylammonium phosphate, diallyldimethyl ammonium hydroxide, diallyldimethyl ammonium chloride, diallyldimethyl ammonium bromide, diallyldimethyl ammonium sulfate, diallyldimethyl ammonium methanesulfonate, diallyldimethyl ammonium phosphate, dimethallyldimethyl ammonium hydroxide, dimethallyldimethyl ammonium chloride, dimethallyldimethyl ammonium bromide, dimethallyldimethyl ammonium sulfate, dimethallyldimethyl ammonium methanesulfonate, dimethallyldimethyl ammonium phosphate, diethallyldimethyl ammonium hydroxide, diethallyldimethyl ammonium chloride, diethallyldimethyl ammonium bromide, diethallyldimethyl ammonium sulfate, diethallyldimethyl ammonium methanesulfonate, diethallyldimethyl ammonium phosphate, diallyl di(beta-hydroxyethyl) ammonium hydroxide, diallyl di(beta-hydroxyethyl) ammonium chloride, diallyl di(beta-hydroxyethyl) ammonium bromide, diallyl di(beta-hydroxyethyl) ammonium sulfate, diallyl di(beta-hydroxyethyl) ammonium methanesulfonate, diallyl di(beta-hydroxyethyl) ammonium phosphate, diallyl di(beta-ethoxyethyl) ammonium hydroxide, diallyl di(beta-ethoxyethyl) ammonium chloride, diallyl di(beta-ethoxyethyl) ammonium bromide, diallyl di(beta-ethoxyethyl) ammonium sulfate, diallyl di(beta-ethoxyethyl) ammonium methanesulfonate, diallyl di(beta-ethoxyethyl) ammonium phosphate, betaine, 3-trimethylammoniumpropanesulfonate, tetraethylammonium hydroxide, tetraethylammonium chloride, tetraethylammonium bromide, tetraethylammonium sulfate, tetraethylammonium methanesulfonate, tetraethylammonium phosphate, tetramethylammonium hydroxide, tetramethylammonium chloride, tetramethylammonium bromide, tetramethylammonium sulfate, tetramethylammonium methanesulfonate, tetramethylammonium phosphate, tetrapropylammonium hydroxide, tetrapropylammonium chloride, tetrapropylammonium bromide, tetrapropylammonium sulfate, tetrapropylammonium methanesulfonate, tetrapropylammonium phosphate, tetrabutylammonium hydroxide, tetrabutylammonium chloride, tetrabutylammonium bromide, tetrabutylammonium sulfate, tetrabutylammonium methanesulfonate, tetrabutylammonium phosphate, tributylmethylammonium hydroxide, tributylmethylammonium chloride, tributylmethylammonium bromide, tributylmethylammonium sulfate, tributylmethylammonium methanesulfonate, tributylmethylammonium phosphate, benzyltrimethylammonium hydroxide, benzyltrimethylammonium chloride, benzyltrimethylammonium bromide, benzyltrimethylammonium sulfate, benzyltrimethylammonium methanesulfonate, benzyltrimethylammonium phosphate, methyl(trishydroxyethyl)ammonium hydroxide, methyl(trishydroxyethyl)ammonium chloride, methyl(trishydroxyethyl)ammonium bromide, methyl(trishydroxyethyl)ammonium sulfate, methyl(trishydroxyethyl)ammonium methanesulfonate, methyl(trishydroxyethyl)ammonium phosphate, ethyltrimethylammonium hydroxide, ethyltrimethylammonium chloride, ethyltrimethylammonium bromide, ethyltrimethylammonium sulfate, ethyltrimethylammonium methanesulfonate, ethyltrimethylammonium phosphate, methyltriethylammonium hydroxide, methyltriethylammonium chloride, methyltriethylammonium bromide, methyltriethylammonium sulfate, methyltriethylammonium methanesulfonate, methyltriethylammonium phosphate, choline hydroxide, choline chloride, choline bromide, choline sulfate, choline methanesulfonate, choline phosphate, methyl tris (hydroxyethyl)ammonium hydroxide, methyl tris(hydroxyethyl)ammonium chloride, methyl tris(hydroxyethyl)ammonium bromide, methyl tris(hydroxyethyl)ammonium sulfate, methyl tris(hydroxyethyl)ammonium methanesulfonate, methyl tris(hydroxyethyl)ammonium phosphate, salts thereof, and combinations thereof. In certain embodiments, the organic compound comprising a quaternary amine is selected from dimeyldiethylammnonium hydroxide, diallyldimethyl ammonium chloride, betaine, 3-trimethylammoniumpropanesulfonate, tetraethylammonium hydroxide (TEAH), tetrabutylammonium hydroxide (TBAH), choline hydroxide, methyl tris (hydroxyethyl) ammonium hydroxide, salts thereof, and combinations thereof.

The composition can comprise any suitable amount of the organic compound comprising a quaternary amine. The composition can comprise about 20 wt. % or less of the organic compound comprising a quaternary amine based on the total weight of the composition, for example, about 10 wt. % or less, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the organic compound comprising a quaternary amine based on the total weight of the composition. Alternatively, or in addition, the composition can comprise about 0.001 wt. % or more of the organic compound comprising a quaternary amine based on the total weight of the composition, for example, about 0.005 wt. % or more, about 0.01 wt. % or more, 0.05 wt. % or more, about 0.1 wt. % or more, about 0.2 wt. % or more, about 0.3 wt. % or more, about 0.4 wt. % or more, about 0.5 wt. % or more, or about 1 wt. % or more of the organic compound comprising a quaternary amine based on the total weight of the composition. Thus, the composition can comprise the organic compound comprising a quaternary amine in any amount bounded by any two of the aforementioned endpoints, as appropriate.

For example, in some embodiments, the organic compound comprising a quaternary amine can be present in the composition in an amount of about 0.001 wt. % to about 20 wt. % based on the total weight of the composition, e.g., about 0.001 wt. % to about 10 wt. %, about 0.001 wt. % to about 8 wt. %, about 0.001 wt. % to about 6 wt. %, about 0.001 wt. % to about 5 wt. %, about 0.001 wt. % to about 4 wt. %, about 0.001 wt. % to about 2 wt. %, about 0.001 wt. % to about 1 wt. %, about 0.001 wt. % to about 0.05 wt. %, about 0.005 wt. % to about 20 wt. %, about 0.005 wt. % to about 10 wt. %, about 0.005 wt. % to about 8 wt. %, about 0.005 wt. % to about 6 wt. %, about 0.005 wt. % to about 5 wt. %, about 0.005 wt. % to about 4 wt. %, about 0.005 wt. % to about 2 wt. %, about 0.005 wt. % to about 1 wt. %, about 0.005 wt. % to about 0.05 wt. %, about 0.05 wt. % to about 20 wt. %, about 0.05 wt. % to about 10 wt. %, about 0.05 wt. % to about 8 wt. %, about 0.05 wt. % to about 6 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.5 wt. % to about 20 wt. %, about 0.5 wt. % to about 10 wt. %, about 0.5 wt. % to about 8 wt. %, about 0.5 wt. % to about 6 wt. %, about 0.5 wt. % to about 5 wt. %, about 0.5 wt. % to about 4 wt. %, about 0.5 wt. % to about 2 wt. %, or about 0.5 wt. % to about 1 wt. % of the organic compound comprising a quaternary amine based on the total weight of the composition. In some embodiments, the composition comprises about 0.1 wt. % to about 5 wt. % of the organic compound comprising a quaternary amine based on the total weight of the composition. In certain embodiments, the composition comprises about 0.1 wt. % to about 1 wt. % of the organic compound comprising a quaternary amine based on the total weight of the composition.

In some embodiments, the composition further comprises one or more water-miscible solvents. Exemplary water-miscible solvents include, but are not limited to, alcohols, glycols, and glycol ethers, including, but not limited to, methanol, ethanol, isopropanol, butanol, and higher alcohols (such as C₂-C₄ diols and C₂-C₄ triols), tetrahydrofurfuryl alcohol (THFA), halogenated alcohols (e.g., 3-chloro-1,2-propanediol, 3-chloro-1-propanethiol, 1-chloro-2-propanol, 2-chloro-1-propanol, 3-chloro-1-propanol, 3-bromo-1,2-propanediol, 1-bromo-2-propanol, 3-bromo-1-propanol, 3-iodo-1-propanol, 4-chloro-1-butanol, and 2-chloroethanol), dichloromethane, chloroform, acetic acid, propionic acid, trifluoroacetic acid, tetrahydrofuran N-methylpyrrolidinone (NMP), cyclohexylpyrrolidinone, N-octylpyrrolidinone, N-phenylpyrrolidinone, methyldiethanolamine, methyl formate, dimethyl formamide (DMF), dimethylsulfoxide (DMSO), tetramethylene sulfone (sulfolane), diethyl ether, phenoxy-2-propanol (PPh), propriophenone, ethyl lactate, ethyl acetate, ethyl benzoate, acetonitrile, acetone, ethylene glycol, propylene glycol (PG), 1,3-propanediol, dioxane, butyryl lactone, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether (i.e., butyl carbitol), triethylene glycol monobutyl ether (TEGMBE), ethylene glycol monohexyl ether, diethylene glycol monohexyl ether, ethylene glycol phenyl ether, propylene glycol methyl ether, propylene glycol monobutyl ether, dipropylene glycol methyl ether (DPGME), tripropylene glycol methyl ether (TPGME), dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, ethylene glycol monophenyl ether, diethylene glycol monophenyl ether hexaethylene glycol monophenylether, dipropylene glycol methyl ether acetate, tetraethylene glycol dimethyl ether (TEGDE), dibasic ester, glycerine carbonate, N-formyl morpholine, triethyl phosphate, and combinations thereof. In certain embodiments, the composition comprises a water-miscible solvent selected from triethylene glycol monobutyl ether, propylene glycol n-butyl ether, propylene glycol monobutyl ether, dimethyl sulfoxide, diethylene glycol monophenyl ether, diethylene glycol monobutyl ether, and combinations thereof.

The composition can comprise any suitable amount of the one or more water-miscible solvents, when present. The composition can comprise about 10 wt. % or less of the one or more water-miscible solvents, when present, based on the total weight of the composition, for example, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the one or more water-miscible solvents, when present, based on the total weight of the composition. Alternatively, or in addition, the composition can comprise about 0.005 wt. % or more of the one or more water-miscible solvents, when present, based on the total weight of the composition, for example, about 0.01 wt. % or more, 0.05 wt. % or more, about 0.1 wt. % or more, or about 0.5 wt. % or more of the one or more water-miscible solvents, when present, based on the total weight of the composition. Thus, the composition can comprise the one or more water-miscible solvents in any amount bounded by any two of the aforementioned endpoints, as appropriate.

For example, in some embodiments, the one or more water-miscible solvents can be present in the composition in an amount of about 0.005 wt. % to about 5 wt. % based on the total weight of the composition, e.g., about 0.005 wt. % to about 4 wt. %, about 0.005 wt. % to about 2 wt. %, about 0.005 wt. % to about 1 wt. %, about 0.005 wt. % to about 0.05 wt. %, about 0.01 wt. % to about 5 wt. %, about 0.01 wt. % to about 4 wt. %, about 0.01 wt. % to about 2 wt. %, about 0.01 wt. % to about 1 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.1 wt. % to about 5 wt. %, about 0.1 wt. % to about 4 wt. %, about 0.1 wt. % to about 2 wt. %, or about 0.1 wt. % to about 1 wt. % of the water-miscible solvents based on the total weight of the composition. In some embodiments, the composition comprises about 0.1 wt. % to about 10 wt. % of the one or more water-miscible solvents, when present, based on the total weight of the composition. In certain embodiments, the composition comprises about 1 wt. % to about 5 wt. % of the one or more water-miscible solvents, when present, based on the total weight of the composition.

In some embodiments, the composition further comprises an amine compound selected from aminoethylethanolamine, N-methylaminoethanol, aminoethoxyethanol, dimethylaminoethoxyethanol, N-methyldiethanolamine, monoethanolamine (MEA), diethanolamine (DEA), triethanolamine (TEA), 1-amino-2-propanol, 2-amino-1-butanol, isobutanolamine, triethylenediamine, 4-(2-hydroxyethyl) morpholine (HEM), 2-amino-2-(hydroxymethyl)-1,3-propanediol, diglycolamine, diisopropanolamine, tris(hydroxymethyl)aminomethane, and combinations thereof. In certain embodiments, the composition further comprises an amine compound selected from monoethanolamine (MEA), diethanolamine (DEA), triethanolamine (TEA), tris(hydroxymethyl)aminomethane, and combinations thereof.

The composition can comprise any suitable amount of the amine compound, when present. The composition can comprise about 10 wt. % or less of the amine compound, when present, based on the total weight of the composition, for example, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the amine compound, when present, based on the total weight of the composition. Alternatively, or in addition, the composition can comprise about 0.005 wt. % or more of the amine compound, when present, based on the total weight of the composition, for example, about 0.01 wt. % or more, 0.05 wt. % or more, about 0.1 wt. % or more, or about 0.5 wt. % or more of the amine compound, when present, based on the total weight of the composition. Thus, the composition can comprise the amine compound in any amount bounded by any two of the aforementioned endpoints, as appropriate.

For example, in some embodiments, the amine compound can be present in the composition in an amount of about 0.005 wt. % to about 5 wt. % based on the total weight of the composition, e.g., about 0.005 wt. % to about 4 wt. %, about 0.005 wt. % to about 2 wt. %, about 0.005 wt. % to about 1 wt. %, about 0.005 wt. % to about 0.05 wt. %, about 0.01 wt. % to about 5 wt. %, about 0.01 wt. % to about 4 wt. %, about 0.01 wt. % to about 2 wt. %, about 0.01 wt. % to about 1 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.1 wt. % to about 5 wt. %, about 0.1 wt. % to about 4 wt. %, about 0.1 wt. % to about 2 wt. %, or about 0.1 wt. % to about 1 wt. % of the amine compound based on the total weight of the composition. In some embodiments, the composition comprises about 0.1 wt. % to about 10 wt. % of the amine compound, when present, based on the total weight of the composition. In certain embodiments, the composition comprises about 1 wt. % to about 5 wt. % of the amine compound, when present, based on the total weight of the composition.

In some embodiments, the composition further comprises an amino acid selected from arginine, histidine, lysine, aspartic acid, glutamic acid, serine, threonine, asparagine, glutamine, cysteine, glycine, proline, alanine, valine, isoleucine, leucine, methionine, phenylalanine, tyrosine, tryptophan, salts thereof, and combinations thereof. In certain embodiments, the composition further comprises an amino acid selected from arginine, histidine, lysine, salts thereof, and combinations thereof.

The composition can comprise any suitable amount of the amino acid, when present. The composition can comprise about 10 wt. % or less of the amino acid, when present, based on the total weight of the composition, for example, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or about 0.5 wt. % or less of the amino acid, when present, based on the total weight of the composition. Alternatively, or in addition, the composition can comprise about 0.005 wt. % or more of the amino acid, when present, based on the total weight of the composition, for example, about 0.01 wt. % or more, 0.05 wt. % or more, about 0.1 wt. % or more, or about 0.5 wt. % or more of the amino acid, when present, based on the total weight of the composition. Thus, the composition can comprise the amino acid in any amount bounded by any two of the aforementioned endpoints, as appropriate.

For example, in some embodiments, the amino acid can be present in the composition in an amount of about 0.005 wt. % to about 5 wt. % based on the total weight of the composition, e.g., about 0.005 wt. % to about 4 wt. %, about 0.005 wt. % to about 2 wt. %, about 0.005 wt. % to about 1 wt. %, about 0.005 wt. % to about 0.05 wt. %, about 0.01 wt. % to about 5 wt. %, about 0.01 wt. % to about 4 wt. %, about 0.01 wt. % to about 2 wt. %, about 0.01 wt. % to about 1 wt. %, about 0.05 wt. % to about 5 wt. %, about 0.05 wt. % to about 4 wt. %, about 0.05 wt. % to about 2 wt. %, about 0.05 wt. % to about 1 wt. %, about 0.1 wt. % to about 5 wt. %, about 0.1 wt. % to about 4 wt. %, about 0.1 wt. % to about 2 wt. %, or about 0.1 wt. % to about 1 wt. % of the amino acid based on the total weight of the composition. In some embodiments, the composition comprises about 0.1 wt. % to about 10 wt. % of the amino acid, when present, based on the total weight of the composition. In certain embodiments, the composition comprises about 0.1 wt. % to about 2 wt. % of the amino acid, when present, based on the total weight of the composition.

In some embodiments, the composition further comprises one or more water-dispersible or water-soluble polymers. Such polymers, when present, include but are not limited to methacrylic acid homopolymer, methacrylic acid copolymers with, for example, acrylamidomethylpropane sulfonic acid and maleic acid, maleic acid and vinyl ether copolymer; poly(vinylpyrrolidone) and vinyl acetate copolymer, phosphonated polyethyleneglycol oligomers, poly(acrylic acid) (PAA), poly(acrylamide), poly(vinyl acetate), poly(ethylene glycol) (PEG), polypropylene glycol (PPG), poly(styrene sulfonic acid), poly(vinyl sulfonic acid), poly(vinyl phosphonic acid), poly(vinyl phosphoric acid), poly(ethyleneimine), poly(propyleneimine), polyallylamine, polyethylene oxide (PEO), polyvinyl pyrrolidone (PVP), PPG-PEG-PPG block copolymers, PEG-PPG-PEG block copolymers, poly(vinyl alcohol), poly(hydroxyethyl)acrylate, poly(hydroxyethyl)methacrylate, hydroxyethyl cellulose, methylhydroxyethyl cellulose, hydroxypropyl cellulose, methylhydroxypropyl cellulose, xanthan gum, potassium alginate, pectin, carboxymethylcellulose, glucosamine, poly(diallyldimethylammonium) chloride, PEGylated (i.e., polyethyleneglycol-ated) methacrylate/acrylate copolymers, polyMADQuat (poly(2-methacryloxyethyltrimethylammonium chloride—CAS Number 26161-33-1) and copolymers thereof, dimethylaminomethacrylate polymers and copolymers thereof, trimethylammonium methylmethacrylate polymers and copolymers thereof, and combinations thereof. The copolymers above may be random or block copolymers. When present, the amount of the one or more water-dispersible or water-soluble polymers in the composition is in a range from about 0.0001 wt. % to about 5 wt. % based on the total weight of the composition. In some embodiments, the composition further comprises one or more water-dispersible or water-soluble polymers selected from poly(acrylic acid) (PAA), poly(ethylene glycol) (PEG), polyvinyl pyrrolidone (PVP), PPG-PEG-PPG block copolymers, PEG-PPG-PEG block copolymers, hydroxyethyl cellulose, methylhydroxyethyl cellulose, hydroxypropyl cellulose, methylhydroxypropyl cellulose, and combinations thereof. In certain embodiments, the composition further comprises one or more water-dispersible or water-soluble polymers selected from hydroxyethyl cellulose, poly(ethylene glycol) (PEG), polyvinyl pyrrolidone (PVP), and combinations thereof.

In some embodiments, the composition further comprises a biocide. The biocide can be any suitable biocide. For example, the biocide can be an isothiazolinone-based biocide such as Kordek MLX™ (DuPont, Wilmington, DE). In certain embodiments, the biocide is 5-chloro-2-methyl-4-isothiazolin-3-one, 2-methyl-4-isothiazolin-3-one, benzisothiazolone, 1,2-benzisothiazol-3[2H]-one, methylisothiazolinone, methylchloroisothiazolinone, or a combination thereof. The composition can comprise any suitable amount of the biocide. For example, the composition can comprise about 0.001 wt. % to about 0.2 wt. % of the biocide.

In some embodiments, the composition further comprises a pH adjustor. The pH adjustor can be any suitable compound capable of adjusting the pH of the composition to a pH of less than about 7. Exemplary pH adjustors include, but are not limited to bases such as, for example, potassium hydroxide, sodium hydroxide, ammonium hydroxide (i.e., aqueous ammonia), and quaternary bases having the formula (PR⁸R⁹R¹⁰R¹¹)OH, wherein R⁸, R⁹, R¹⁰, and R¹¹ are each independently chosen from hydrogen, straight-chain C₁-C₆ alkyl (e.g., methyl, ethyl, propyl, butyl, pentyl, and hexyl) groups, branched C₁-C₆ alkyl groups, C₁-C₆ hydroxyalkyl (e.g., hydroxymethyl, hydroxyethyl, hydroxypropyl, hydroxybutyl, hydroxypentyl, and hydroxyhexyl) groups, substituted C₆-C₁₀ aryl groups, and unsubstituted C₆-C₁₀ aryl groups (e.g., benzyl groups), such as tetrabutylphosphonium hydroxide (TBPH), tetramethylphosphonium hydroxide, tetraethylphosphonium hydroxide, tetrapropylphosphonium hydroxide, benzyltriphenylphosphonium hydroxide, methyl triphenylphosphonium hydroxide, ethyl triphenylphosphonium hydroxide, and N-propyl triphenylphosphonium hydroxide. Exemplary pH adjustors further include, but are not limited to acids such as, for example, nitric acid, sulfuric acid, phosphoric acid, methanesulfonic acid, and organic acids such as formic acid and acetic acid. In some embodiments, the pH adjustor is selected from potassium hydroxide, nitric acid, sulfuric acid, phosphoric acid, methanesulfonic acid, salts thereof, and combinations thereof. In certain embodiments, the pH adjustor is nitric acid.

The composition can comprise any suitable amount of the pH adjustor. Generally, the composition comprises the pH adjustor in an amount so as to maintain the pH of the composition in the range of less than about 7.

The composition can have any suitable pH. Typically, the composition has a pH of about 7 or less, e.g., about 6.5 or less, about 6 or less, about 5.5 or less, about 5 or less, about 4.5 or less, or about 4 or less. Alternatively, or in addition, the composition can have a pH of about 0 or more, e.g., about 0.5 or more, about 1 or more, about 1.5 or more, or about 2 or more. Thus, the composition can have a pH bounded by any two of the aforementioned endpoints. For example, the composition can have a pH of about 0 to about 7, e.g., about 0 to about 6, about 0 to about 5, about 1 to about 7, about 1 to about 6, about 1 to about 5, about 2 to about 7, about 2 to about 6, about 2 to about 5. In some embodiments, the composition has a pH of about 1 to about 6. In certain embodiments, the composition has a pH of about 2 to about 5. The pH of the composition can be adjusted using any suitable pH adjustor described herein in sufficient quantities to achieve such pH ranges.

In some embodiments, the invention provides a composition comprising (a) water, (b) about 0.1 wt. % to about 5 wt. % of a sulfonated polymer, a sulfonated alkyl amine compound, or a combination thereof, (c) about 1 wt. % to about 20 wt. % of a chelating agent, and (d) about 0.1 wt. % to about 5 wt. % of an organic compound comprising a quaternary amine, wherein the composition has a pH of less than about 7.

In some embodiments, the invention provides a composition comprising (a) water, (b) about 0.1 wt. % to about 2 wt. % of a sulfonated polymer, a sulfonated alkyl amine compound, or a combination thereof, (c) about 1 wt. % to about 10 wt. % of a chelating agent, and (d) about 0.1 wt. % to about 1 wt. % of an organic compound comprising a quaternary amine, wherein the composition has a pH of less than about 7.

In some embodiments, the invention provides a composition comprising (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, wherein the composition has a pH of less than about 7.

In some embodiments, the invention provides a composition comprising (a) water, (b) about 0.1 wt. % to about 5 wt. % of a sulfonated polymer, a sulfonated alkyl amine compound, or a combination thereof, (c) about 1 wt. % to about 20 wt. % of a chelating agent, (d) about 0.1 wt. % to about 5 wt. % of an organic compound comprising a quaternary amine, and (e) a water-miscible solvent, wherein the composition has a pH of less than about 7.

In some embodiments, the invention provides a composition comprising (a) water, (b) about 0.1 wt. % to about 2 wt. % of a sulfonated polymer, a sulfonated alkyl amine compound, or a combination thereof, (c) about 1 wt. % to about 10 wt. % of a chelating agent, (d) about 0.1 wt. % to about 1 wt. % of an organic compound comprising a quaternary amine, and (e) a water-miscible solvent, wherein the composition has a pH of less than about 7.

In some embodiments, the invention provides a composition comprising (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, and (e) a water-miscible solvent, wherein the composition has a pH of less than about 7.

In some embodiments, the invention provides a composition comprising (a) water, (b) about 0.1 wt. % to about 5 wt. % of a sulfonated polymer, a sulfonated alkyl amine compound, or a combination thereof, (c) about 1 wt. % to about 20 wt. % of a chelating agent, (d) about 0.1 wt. % to about 5 wt. % of an organic compound comprising a quaternary amine, and (e) triethylene glycol monobutyl ether (TEGMBE), wherein the composition has a pH of less than about 7.

In some embodiments, the invention provides a composition comprising (a) water, (b) about 0.1 wt. % to about 2 wt. % of a sulfonated polymer, a sulfonated alkyl amine compound, or a combination thereof, (c) about 1 wt. % to about 10 wt. % of a chelating agent, (d) about 0.1 wt. % to about 1 wt. % of an organic compound comprising a quaternary amine, and (e) triethylene glycol monobutyl ether (TEGMBE), wherein the composition has a pH of less than about 7.

In some embodiments, the invention provides a composition comprising (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, and (e) triethylene glycol monobutyl ether (TEGMBE), wherein the composition has a pH of less than about 7.

In some embodiments, the invention provides a composition comprising (a) water, (b) about 0.1 wt. % to about 5 wt. % of a sulfonated polymer, a sulfonated alkyl amine compound, or a combination thereof, (c) about 1 wt. % to about 20 wt. % of a chelating agent, (d) about 0.1 wt. % to about 5 wt. % of an organic compound comprising a quaternary amine, (e) a water-miscible solvent, and (f) an amine compound, wherein the composition has a pH of less than about 7.

In some embodiments, the invention provides a composition comprising (a) water, (b) about 0.1 wt. % to about 2 wt. % of a sulfonated polymer, a sulfonated alkyl amine compound, or a combination thereof, (c) about 1 wt. % to about 10 wt. % of a chelating agent, (d) about 0.1 wt. % to about 1 wt. % of an organic compound comprising a quaternary amine, (e) a water-miscible solvent, and (f) an amine compound, wherein the composition has a pH of less than about 7.

In some embodiments, the invention provides a composition comprising (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, (e) a water-miscible solvent, and (f) an amine compound, wherein the composition has a pH of less than about 7.

In some embodiments, the invention provides a composition comprising (a) water, (b) about 0.1 wt. % to about 5 wt. % of a sulfonated polymer, a sulfonated alkyl amine compound, or a combination thereof, (c) about 1 wt. % to about 20 wt. % of a chelating agent, (d) about 0.1 wt. % to about 5 wt. % of an organic compound comprising a quaternary amine, (e) triethylene glycol monobutyl ether (TEGMBE), and (f) an amine compound, wherein the composition has a pH of less than about 7.

In some embodiments, the invention provides a composition comprising (a) water, (b) about 0.1 wt. % to about 2 wt. % of a sulfonated polymer, a sulfonated alkyl amine compound, or a combination thereof, (c) about 1 wt. % to about 10 wt. % of a chelating agent, (d) about 0.1 wt. % to about 1 wt. % of an organic compound comprising a quaternary amine, (e) triethylene glycol monobutyl ether (TEGMBE), and (f) an amine compound, wherein the composition has a pH of less than about 7.

In some embodiments, the invention provides a composition comprising (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, (e) triethylene glycol monobutyl ether (TEGMBE), and (f) an amine compound, wherein the composition has a pH of less than about 7.

In some embodiments, the invention provides a composition comprising (a) water, (b) about 0.1 wt. % to about 5 wt. % of a sulfonated polymer, a sulfonated alkyl amine compound, or a combination thereof, (c) about 1 wt. % to about 20 wt. % of a chelating agent, (d) about 0.1 wt. % to about 5 wt. % of an organic compound comprising a quaternary amine, (e) a water-miscible solvent, and (f) an amine compound, wherein the composition has a pH of less than about 7.

In some embodiments, the invention provides a composition comprising (a) water, (b) about 0.1 wt. % to about 2 wt. % of a sulfonated polymer, a sulfonated alkyl amine compound, or a combination thereof, (c) about 1 wt. % to about 10 wt. % of a chelating agent, (d) about 0.1 wt. % to about 1 wt. % of an organic compound comprising a quaternary amine, (e) a water-miscible solvent, and (f) monoethanolamine, diethanolamine, triethanolamine, tris(hydroxymethyl)aminomethane, or a combination thereof, wherein the composition has a pH of less than about 7.

In some embodiments, the invention provides a composition comprising (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, (e) a water-miscible solvent, and (f) monoethanolamine, diethanolamine, triethanolamine, tris(hydroxymethyl)aminomethane, or a combination thereof, wherein the composition has a pH of less than about 7.

In some embodiments, the invention provides a composition comprising (a) water, (b) about 0.1 wt. % to about 5 wt. % of a sulfonated polymer, a sulfonated alkyl amine compound, or a combination thereof, (c) about 1 wt. % to about 20 wt. % of a chelating agent, (d) about 0.1 wt. % to about 5 wt. % of an organic compound comprising a quaternary amine, (e) triethylene glycol monobutyl ether (TEGMBE), and (f) monoethanolamine, diethanolamine, triethanolamine, tris(hydroxymethyl)aminomethane, or a combination thereof, wherein the composition has a pH of less than about 7.

In some embodiments, the invention provides a composition comprising (a) water, (b) about 0.1 wt. % to about 2 wt. % of a sulfonated polymer, a sulfonated alkyl amine compound, or a combination thereof, (c) about 1 wt. % to about 10 wt. % of a chelating agent, (d) about 0.1 wt. % to about 1 wt. % of an organic compound comprising a quaternary amine, (e) triethylene glycol monobutyl ether (TEGMBE), and (f) monoethanolamine, diethanolamine, triethanolamine, tris(hydroxymethyl)aminomethane, or a combination thereof, wherein the composition has a pH of less than about 7.

In some embodiments, the invention provides a composition comprising (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, (e) triethylene glycol monobutyl ether (TEGMBE), and (f) monoethanolamine, diethanolamine, triethanolamine, tris(hydroxymethyl)aminomethane, or a combination thereof, wherein the composition has a pH of less than about 7.

The compositions of the invention can be prepared and then sold in the form a concentrate, which contains water at a relatively low amount, and, consequently, a relatively concentrated amount of non-aqueous ingredients. The concentrate can be prepared commercially to be sold and transported while containing the concentrated amount of non-aqueous ingredients and relatively reduced amount of water, and to be eventually diluted by a purchaser of the concentrate at a point of use. The amounts of the different non-aqueous ingredients in the concentrate are amounts that, upon dilution of the concentrate, will result in desired amounts of those non-aqueous ingredients being present in the composition as ultimately utilized.

The composition of the invention can be easily prepared by simple addition of the respective ingredients and mixing to homogeneous condition, such as a solution. Furthermore, a composition may be readily formulated as single-package formulations or multi-part formulations that are mixed at or before the point of use, e.g., the individual parts of the multi-part formulation may be mixed by a user either at a processing tool (cleaning apparatus) or in a storage tank upstream of the processing tool.

Thus, the composition can be supplied as a one-package system comprising water, sulfonated polymer, chelating agent, organic compound comprising a quaternary amine, and/or any optional additive. Alternatively, the composition of the invention can be supplied as a two-package system. The two-package system allows for the adjustment of composition characteristics by changing the blending ratio of the two packages. Similarly, a three-, four-, or more package system can be utilized in connection with the invention, wherein each of multiple containers contains different components of the inventive composition, one or more optional additives, and/or one or more of the same components in different concentrations.

Accordingly, another aspect of the invention relates to a kit including, in two or more containers, various components of the composition described herein, suitable for storing and shipping the compositions and may include, for example, NOWPAK™ containers (Entegris, Inc., Billerica, MA, USA). Thus, the invention also provides a kit comprising, in two or more containers, two or more of:
(a) water,
(b) a sulfonated polymer, a sulfonated alkyl amine compound, or a combination thereof,
(c) a chelating agent, and
(d) an organic compound comprising a quaternary amine.

In some embodiments, the kit comprises, in two or more containers, two or more of:
(a) water,
(b) a sulfonated polymer, a sulfonated alkyl amine compound, or a combination thereof,
(c) a chelating agent,
(d) an organic compound comprising a quaternary amine, and
(e) a water-miscible solvent.

In certain embodiments, the kit comprises, in two or more containers, two or more of:
(a) water,
(b) a sulfonated polymer, a sulfonated alkyl amine compound, or a combination thereof,
(c) a chelating agent,
(d) an organic compound comprising a quaternary amine,
(e) a water-miscible solvent, and
(f) an amine compound.

The invention further provides a method for removing residue from a surface of a microelectronic device substrate, the method comprising (i) contacting the surface of the microelectronic device substrate with a composition comprising: (a) water, (b) a sulfonated polymer, a sulfonated alkyl amine compound, or a combination thereof, (c) a chelating agent, and (d) an organic compound comprising a quaternary amine, wherein the composition has a pH of less than about 7, and (ii) removing at least a portion of the residue from the surface of the microelectronic device substrate.

As used herein, the term “residue” (which is inclusive of a “contaminant”) refers to any material that is a chemical or particulate material that remains present at a surface of a microelectronic device substrate after a processing step used in the fabrication of a microelectronic device, for example, processing steps including plasma etching, plasma ashing (to remove photoresist from an etched wafer), chemical-mechanical processing, wet etching, etc. The residue may be any non-aqueous chemical material that is part of a processing composition used in the processing step, such as a chemical etchant, a photoresist, a CMP slurry, etc. The residue may alternately be a substance that is derived from a material of the processing composition during a processing step. Examples of these types of residues include non-aqueous, particulate or non-particulate, chemical or abrasive materials (e.g., abrasive particles, surfactant, oxidizer, corrosion inhibitor, catalyst) that remain at a surface of the substrate after processing. The residue may be originally present in a material such as a CMP slurry or an etching composition, such as a solid abrasive particle or chemical material present in a CMP abrasive slurry. Alternately, or additionally, a residue may be a by-product or a reaction product (in particulate (e.g., agglomerate or precipitate) or non-particulate form) that is generated during processing, e.g., a by-product or reaction product of a chemical present in a processing composition such as CMP slurry or wet etching composition, or a chemical that is present, used during, or produced during a plasma etching or a plasma ashing process.

The term “post-CMP residue” refers to residue that is present at an end of a CMP processing step, for example, a particle or chemical material that is present in or derived from a CMP slurry. Specific examples of post-CMP residues include, but are not limited to, abrasive particles (e.g., silica-containing or silica-based abrasive particles, metal oxide (e.g., alumina) particles, ceria or ceria-based particles, and the like), chemicals that are originally present in the slurry (e.g., an oxidizer, catalyst, surfactant, inhibitor, complexing agent, etc.), a metal, metal oxide, or metal complex that is derived from a metal material removed from the substrate surface being processed, or a reaction product or complex produced using a chemical of the slurry with another chemical of the slurry or with a chemical material derived from the substrate (e.g., a metal ion, pad particles, or any other material that is a product of the CMP process).

A “post-etch residue” refers to a material remaining following a gas-phase plasma etching process, e.g., back-end-of-line (“BEOL”) dual damascene processing, or wet etching processes. A post-etch residue may be organic, organometallic, organosilicic, or inorganic in nature, for example, silicon-containing material, carbon-based organic material, and etch gas residues such as oxygen residues and fluorine residues.

A “post-ash residue” refers to material remaining following oxidative or reductive plasma ashing to remove hardened photoresist and/or bottom anti-reflective coating (BARC) materials. The post-ash residue may be organic, organometallic, organosilicic, or inorganic in nature.

As noted above, the present invention relates to compositions which are useful in a cleaning method that removes residue from a surface of a microelectronic device substrate that has residue thereon. The compositions contain an aqueous carrier (i.e., water) along with a combination of other ingredients as set forth herein. In certain embodiments, the compositions, before being used in a cleaning process, are homogeneous solutions that comprise, consist of, or consist essentially of water and dissolved non-aqueous ingredients, in the absence of any solid or suspended materials such as solid abrasive particles, agglomerates, coagulates, etc.

The compositions as described herein are useful for cleaning microelectronic devices and precursors thereof, specifically including microelectronic device substrates, meaning semiconductor wafers that include on a surface one or more microelectronic devices or precursors thereof that are in the process of being fabricated into final, completed, and functional microelectronic devices.

The microelectronic device substrate can comprise any suitable material such as, for example, conductive materials or non-conductive materials (e.g., tantalum (Ta), tantalum nitride (TaNx), tungsten (W), titanium (Ti), titanium nitride (TiN), ruthenium (Ru), cobalt (Co), molybdenum (Mo), rhenium (Rh), and alloys thereof) and dielectric materials (e.g., PETEOS, SiO2, thermal oxide, silicon nitride, silicon, etc.). In some embodiments, the microelectronic device substrate comprises a molybdenum layer and/or a tungsten layer on a surface thereof. In certain embodiments, the microelectronic device substrate comprises a molybdenum layer on a surface thereof. In other embodiments, the microelectronic device substrate comprises a tungsten layer on a surface thereof.

As used herein, a microelectronic device is a device that includes electrical circuits and related structures of very small (e.g., micron-scale or smaller) dimensions formed thereon. Exemplary microelectronic devices include flat panel displays, integrated circuits, memory devices, solar panels, photovoltaics, and microelectromechanical systems (MEMS). A microelectronic device substrate is a structure such as a wafer (e.g., semiconductor wafer) that includes one or more microelectronic devices or precursors thereof, in a state of being prepared to form a final microelectronic device.

The compositions and methods described herein are useful to clean any of various forms of microelectronic devices, at any stage of processing. The compositions and method of the invention are effective to remove at least a portion of the residue from the surface of the microelectronic device substrate. In some embodiments, the compositions and methods described herein are effective to remove a substantial amount (e.g., at least 50% or more, at least 60% or more, or at least 70% or more) of residue from the surface, relative to an amount that is initially present at the surface before the cleaning step. In certain embodiments, a high percentage of residue that is present at a substrate surface can be successfully removed from the surface by use of compositions (i.e., cleaning compositions) and methods described herein. For example, the compositions (i.e., cleaning compositions) and methods described herein can be effective, in a cleaning step, to remove at least 80% of residue present on a surface of the substrate prior to residue removal by a cleaning step, at least 85% of residue, at least 90% of residue, at least 95% of residue, or at least 99% of residue from the surface, relative to an amount that is initially present at the surface before the cleaning step.

Methods and equipment for measuring residue at a surface of a microelectronic device substrate are well known. Cleaning efficiency may be rated based on a reduction of an amount (e.g., number) of residue particles present on a microelectronic device surface after cleaning, compared to the amount (e.g., number) of residue particles present before cleaning. For example, pre- and post-cleaning analysis may be carried out using an atomic force microscope. Residue particles on a surface may be registered as a range of pixels. A histogram (e.g., a Sigma Scan Pro) may be applied to filter the pixels in a certain intensity, e.g., 231-235, and the number of residue particles counted. The amount of residue particle removal, i.e., cleaning efficiency, may be calculated using the following ratio: (Number of PreClean Residue Particles on a Surface-Number of PostClean Residue Particles on the Surface)/(Number of PreClean Residue Particles on the Surface).

Alternately, cleaning efficiency may be considered as a percentage of a total amount of a substrate surface that is covered by residue particulate matter before as compared to after cleaning. For example, an atomic force microscope may be programmed to perform a z-plane scan to identify topographic areas of interest above a certain height threshold, and then calculate the area of the total surface covered by the areas of interest. A reduced amount of area determined to be areas of interest, after cleaning, indicates a more efficacious cleaning composition and cleaning process.

In a cleaning step, such as a post-CMP residue cleaning step, a cleaning composition may be used with any of a variety of known, conventional, commercially available cleaning tools such as megasonics and brush scrubbing, including, but not limited to, Verteq single wafer megasonic Goldfinger, OnTrak systems DDS (double-sided scrubbers), SEZ or other single wafer spray rinse, Applied Materials Mirra-MESA™/REFLEXION™/REFLEXION LK™, and Megasonic batch wet bench systems, and Ebara Technologies, Inc. products such as 300 mm models (FREX300S2 and FREX300X3SC) and the 200 mm CMP system (FREX200M).

Conditions and timing of a cleaning step can be as desired, and may vary depending on the type of substrate and residue. In use of a composition for cleaning post-CMP residue, post-etch residue, post-ash residue or contaminants from a microelectronic device substrate having the same thereon, the compositions (i.e., cleaning compositions) may be contacted with the substrate surface for a time of from about 1 second to about 20 minutes, e.g., from about 5 seconds to 10 minutes, or from about 15 seconds to about 5 minutes, at temperature in a range of from about 20° C. to about 90° C., or about 20° C. to about 50° C. Such contacting times and temperatures are illustrative, and any other suitable time and temperature conditions may be useful if efficacious to at least partially clean an initial amount of residue from a surface.

Following the desired level of cleaning of a device substrate surface, the compositions (i.e., cleaning compositions) used in a cleaning step may be readily removed from the device surface, as may be desired and efficacious in a given end use application. For example, removal may be performed by use of a rinse solution that includes deionized water. Thereafter, the device may be processed as desired, such as by being dried (e.g., using nitrogen or a spin-dry cycle), followed by subsequent processing of the cleaned and dried device surface.

In other more general or specific methods, a microelectronic device substrate may first be subjected to a processing step that includes by any one or more of CMP processing, plasma etching, wet etching, plasma ashing, or the like, followed by a cleaning step that includes cleaning the substrate surface with the composition of the present invention. At the end of the first processing step, residue (e.g., post-etch residue, post-CMP residue, post ash residue, etc.) will be present at a surface of the substrate. The cleaning step, using a compositions (i.e., cleaning compositions) as described, will be effective to clean a substantial amount of the residue from the microelectronic device surface.

The invention further provides a method for removing residue from a surface of a microelectronic device substrate, the method comprising (i) contacting the surface of the microelectronic device substrate with a composition comprising: (a) water, (b) about 0.001 wt. % to about 5 wt. % of a sulfonated polymer, a sulfonated alkyl amine compound, or a combination thereof, (c) about 0.001 wt. % to about 20 wt. % of a chelating agent, and (d) about 0.001 wt. % to about 5 wt. % of an organic compound comprising a quaternary amine, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 2 wt. % of a sulfonated polymer, a sulfonated alkyl amine compound, or a combination thereof, (c) about 0.001 wt. % to about 10 wt. % of a chelating agent, and (d) about 0.001 wt. % to about 1 wt. % of an organic compound comprising a quaternary amine, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 5 wt. % of a sulfonated polymer, a sulfonated alkyl amine compound, or a combination thereof, (c) about 0.001 wt. % to about 20 wt. % of a chelating agent, (d) about 0.001 wt. % to about 5 wt. % of an organic compound comprising a quaternary amine, and (e) a water-miscible solvent, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 2 wt. % of a sulfonated polymer, a sulfonated alkyl amine compound, or a combination thereof, (c) about 0.001 wt. % to about 10 wt. % of a chelating agent, (d) about 0.001 wt. % to about 1 wt. % of an organic compound comprising a quaternary amine, and (e) a water-miscible solvent, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, and (e) a water-miscible solvent, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 5 wt. % of a sulfonated polymer, a sulfonated alkyl amine compound, or a combination thereof, (c) about 0.001 wt. % to about 20 wt. % of a chelating agent, (d) about 0.001 wt. % to about 5 wt. % of an organic compound comprising a quaternary amine, and (e) triethylene glycol monobutyl ether (TEGMBE), wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 2 wt. % of a sulfonated polymer, a sulfonated alkyl amine compound, or a combination thereof, (c) about 0.001 wt. % to about 10 wt. % of a chelating agent, (d) about 0.001 wt. % to about 1 wt. % of an organic compound comprising a quaternary amine, and (e) triethylene glycol monobutyl ether (TEGMBE), wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, and (e) triethylene glycol monobutyl ether (TEGMBE), wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 5 wt. % of a sulfonated polymer, a sulfonated alkyl amine compound, or a combination thereof, (c) about 0.001 wt. % to about 20 wt. % of a chelating agent, (d) about 0.001 wt. % to about 5 wt. % of an organic compound comprising a quaternary amine, (e) a water-miscible solvent, and (f) an amine compound, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 2 wt. % of a sulfonated polymer, a sulfonated alkyl amine compound, or a combination thereof, (c) about 0.001 wt. % to about 10 wt. % of a chelating agent, (d) about 0.001 wt. % to about 1 wt. % of an organic compound comprising a quaternary amine, (e) a water-miscible solvent, and (f) an amine compound, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, (e) a water-miscible solvent, and (f) an amine compound, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 5 wt. % of a sulfonated polymer, a sulfonated alkyl amine compound, or a combination thereof, (c) about 0.001 wt. % to about 20 wt. % of a chelating agent, (d) about 0.001 wt. % to about 5 wt. % of an organic compound comprising a quaternary amine, (e) triethylene glycol monobutyl ether (TEGMBE), and (f) an amine compound, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 2 wt. % of a sulfonated polymer, a sulfonated alkyl amine compound, or a combination thereof, (c) about 0.001 wt. % to about 10 wt. % of a chelating agent, (d) about 0.001 wt. % to about 1 wt. % of an organic compound comprising a quaternary amine, (e) triethylene glycol monobutyl ether (TEGMBE), and (f) an amine compound, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, (e) triethylene glycol monobutyl ether (TEGMBE), and (f) an amine compound, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 5 wt. % of a sulfonated polymer, a sulfonated alkyl amine compound, or a combination thereof, (c) about 0.001 wt. % to about 20 wt. % of a chelating agent, (d) about 0.001 wt. % to about 5 wt. % of an organic compound comprising a quaternary amine, (e) a water-miscible solvent, and (f) an amine compound, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 2 wt. % of a sulfonated polymer, a sulfonated alkyl amine compound, or a combination thereof, (c) about 0.001 wt. % to about 10 wt. % of a chelating agent, (d) about 0.001 wt. % to about 1 wt. % of an organic compound comprising a quaternary amine, (e) a water-miscible solvent, and (f) monoethanolamine, diethanolamine, triethanolamine, tris(hydroxymethyl)aminomethane, or a combination thereof, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, (e) a water-miscible solvent, and (f) monoethanolamine, diethanolamine, triethanolamine, tris(hydroxymethyl)aminomethane, or a combination thereof, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 5 wt. % of a sulfonated polymer, a sulfonated alkyl amine compound, or a combination thereof, (c) about 0.001 wt. % to about 20 wt. % of a chelating agent, (d) about 0.001 wt. % to about 5 wt. % of an organic compound comprising a quaternary amine, (e) triethylene glycol monobutyl ether (TEGMBE), and (f) monoethanolamine, diethanolamine, triethanolamine, tris(hydroxymethyl)aminomethane, or a combination thereof, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) about 0.001 wt. % to about 2 wt. % of a sulfonated polymer, a sulfonated alkyl amine compound, or a combination thereof, (c) about 1 wt. % to about 10 wt. % of a chelating agent, (d) about 0.001 wt. % to about 0.001 wt. % of an organic compound comprising a quaternary amine, (e) triethylene glycol monobutyl ether (TEGMBE), and (f) monoethanolamine, diethanolamine, triethanolamine, tris(hydroxymethyl)aminomethane, or a combination thereof, wherein the composition has a pH of less than about 7, and (ii) removing at least a portion of the residue from the surface of the microelectronic device substrate.

The invention further provides a method for removing residue from a surface of a microelectronic device substrate, the method comprising (i) contacting the surface of the microelectronic device substrate with a composition comprising: (a) water, (b) polystyrene sulfonic acid or a salt thereof, (c) citric acid, hydroxyethylidene diphosphonic acid (HEDP), or a combination thereof and (d) betaine, diallyldimethyl ammonium chloride, a salt thereof, or a combination thereof, (e) triethylene glycol monobutyl ether (TEGMBE), and (f) monoethanolamine, diethanolamine, triethanolamine, tris(hydroxymethyl)aminomethane, or a combination thereof, wherein the composition has a pH of less than about 7, and (ii) removing at least a portion of the residue from the surface of the microelectronic device substrate.

Aspects, including embodiments, of the invention described herein may be beneficial alone or in combination, with one or more other aspects or embodiments. Without limiting the foregoing description, certain non-limiting embodiments of the disclosure numbered 1-38 are provided below. As will be apparent to those of skill in the art upon reading this disclosure, each of the individually numbered embodiments may be used or combined with any of the preceding or following individually numbered embodiments. This is intended to provide support for all such combinations of embodiments and is not limited to combinations of embodiments explicitly provided below:

### EMBODIMENTS

(1) In embodiment (1) is presented a composition comprising:
(a) water,
(b) a sulfonated polymer, a sulfonated alkyl amine compound, or a combination thereof,
(c) a chelating agent, and
(d) an organic compound comprising a quaternary amine, wherein the composition has a pH of less than about 7.

(2) In embodiment (2) is presented the composition of embodiment (1), wherein the sulfonated polymer comprises a monomer unit derived from a monomer selected from 2-acrylamido-2-methylpropane sulfonic acid, 2-methylacrylamido-2-methylpropane sulfonic acid, styrene sulfonic acid, vinyl sulfonic acid, 3-allyloxy-2-hydroxy-1-propanesulfonic acid, 2-sulfoethyl methacrylate, 2-sulfoethylacrylate, 3-sulfopropyl methacrylate, 3-sulfopropyl acrylate, salts thereof, and combinations thereof.

(3) In embodiment (3) is presented the composition of embodiment (1) or embodiment (2), wherein the sulfonated polymer comprises a monomer unit derived from a monomer selected from 2-acrylamido-2-methylpropane sulfonic acid, styrene sulfonic acid, salts thereof, and combinations thereof.

(4) In embodiment (4) is presented the composition of any one of embodiments (1)-(3), wherein the sulfonated polymer further comprises one or more additional monomer units derived from a (meth)acrylate monomer, a (meth)acrylamido monomer, a styrenic monomer, a vinylic monomer, or a combination thereof.

(5) In embodiment (5) is presented the composition of any one of embodiments (1)-(3), wherein the sulfonated polymer is polystyrene sulfonic acid or a salt thereof.

(6) In embodiment (6) is presented the composition of any one of embodiments (1)-(5), wherein the chelating agent comprises ethylenediamine tetraacetic acid (EDTA), hydroxyethylethylenediamine triacetic (HEDTA), cyclohexane diamine tetraacetic acid (CDTA), and diethylenetriamine pentaacetic acid (DETPA), hydroxyethylidene diphosphonic acid (HEDP), diethylenetriamine pentamethylene phosphonic acid, bis (hexamethylene) triaminepenta (methylenephosphonic) acid, nitrilotri(methylphosphonic acid), hexamethylenediamine-N,N,N′,N′-tetrakis (methylphosphonic acid), 2-phosphono-1,2,4-butane carboxylic acid, citric acid, ascorbic acid, picolinic acid, dipicolinic acid, salts thereof, or a combination thereof.

(7) In embodiment (7) is presented the composition of any one of embodiments (1)-(6), wherein the chelating agent comprises hydroxyethylidene diphosphonic acid (HEDP), nitrilotri(methylphosphonic acid), citric acid, picolinic acid, dipicolinic acid, salts thereof, or a combination thereof.

(8) In embodiment (8) is presented the composition of any one of embodiments (1)-(7), wherein the organic compound comprising a quaternary amine is selected from dimethyldiethylammnonium hydroxide, dimethyldiethylammnonium chloride, dimethyldiethylammnonium bromide, dimethyldiethylammnonium sulfate, dimethyldiethylammonium methanesulfonate, dimethyldiethylammonium phosphate, diallyldimethyl ammonium hydroxide, diallyldimethyl ammonium chloride, diallyldimethyl ammonium bromide, diallyldimethyl ammonium sulfate, diallyldimethyl ammonium methanesulfonate, diallyldimethyl ammonium phosphate, dimethallyldimethyl ammonium hydroxide, dimethallyldimethyl ammonium chloride, dimethallyldimethyl ammonium bromide, dimethallyldimethyl ammonium sulfate, dimethallyldimethyl ammonium methanesulfonate, dimethallyldimethyl ammonium phosphate, diethallyldimethyl ammonium hydroxide, diethallyldimethyl ammonium chloride, diethallyldimethyl ammonium bromide, diethallyldimethyl ammonium sulfate, diethallyldimethyl ammonium methanesulfonate, diethallyldimethyl ammonium phosphate, diallyl di(beta-hydroxyethyl) ammonium hydroxide, diallyl di(beta-hydroxyethyl) ammonium chloride, diallyl di(beta-hydroxyethyl) ammonium bromide, diallyl di(beta-hydroxyethyl) ammonium sulfate, diallyl di(beta-hydroxyethyl) ammonium methanesulfonate, diallyl di(beta-hydroxyethyl) ammonium phosphate, diallyl di(beta-ethoxyethyl) ammonium hydroxide, diallyl di(beta-ethoxyethyl) ammonium chloride, diallyl di(beta-ethoxyethyl) ammonium bromide, diallyl di(beta-ethoxyethyl) ammonium sulfate, diallyl di(beta-ethoxyethyl) ammonium methanesulfonate, diallyl di(beta-ethoxyethyl) ammonium phosphate, betaine, 3-trimethylammoniumpropanesulfonate, tetraethylammonium hydroxide, tetraethylammonium chloride, tetraethylammonium bromide, tetraethylammonium sulfate, tetraethylammonium methanesulfonate, tetraethylammonium phosphate, tetramethylammonium hydroxide, tetramethylammonium chloride, tetramethylammonium bromide, tetramethylammonium sulfate, tetramethylammonium methanesulfonate, tetramethylammonium phosphate, tetrapropylammonium hydroxide, tetrapropylammonium chloride, tetrapropylammonium bromide, tetrapropylammonium sulfate, tetrapropylammonium methanesulfonate, tetrapropylammonium phosphate, tetrabutylammonium hydroxide, tetrabutylammonium chloride, tetrabutylammonium bromide, tetrabutylammonium sulfate, tetrabutylammonium methanesulfonate, tetrabutylammonium phosphate, tributylmethylammonium hydroxide, tributylmethylammonium chloride, tributylmethylammonium bromide, tributylmethylammonium sulfate, tributylmethylammonium methanesulfonate, tributylmethylammonium phosphate, benzyltrimethylammonium hydroxide, benzyltrimethylammonium chloride, benzyltrimethylammonium bromide, benzyltrimethylammonium sulfate, benzyltrimethylammonium methanesulfonate, benzyltrimethylammonium phosphate, methyl(trishydroxyethyl)ammonium hydroxide, methyl(trishydroxyethyl)ammonium chloride, methyl(trishydroxyethyl)ammonium bromide, methyl(trishydroxyethyl)ammonium sulfate, methyl(trishydroxyethyl)ammonium methanesulfonate, methyl(trishydroxyethyl)ammonium phosphate, ethyltrimethylammonium hydroxide, ethyltrimethylammonium chloride, ethyltrimethylammonium bromide, ethyltrimethylammonium sulfate, ethyltrimethylammonium methanesulfonate, ethyltrimethylammonium phosphate, methyltriethylammonium hydroxide, methyltriethylammonium chloride, methyltriethylammonium bromide, methyltriethylammonium sulfate, methyltriethylammonium methanesulfonate, methyltriethylammonium phosphate, choline hydroxide, choline chloride, choline bromide, choline sulfate, choline methanesulfonate, choline phosphate, methyl tris (hydroxyethyl)ammonium hydroxide, methyl tris(hydroxyethyl)ammonium chloride, methyl tris(hydroxyethyl)ammonium bromide, methyl tris(hydroxyethyl)ammonium sulfate, methyl tris(hydroxyethyl)ammonium methanesulfonate, methyl tris(hydroxyethyl)ammonium phosphate, salts thereof, and combinations thereof.

(9) In embodiment (9) is presented the composition of any one of embodiments (1)-(8), wherein the organic compound comprising a quaternary amine is selected from dimethyldiethylammnonium hydroxide, diallyldimethyl ammonium chloride, betaine, 3-trimethylammoniumpropanesulfonate, tetraethylammonium hydroxide (TEAH), tetrabutylammonium hydroxide (TBAH), choline hydroxide, methyl tris (hydroxyethyl) ammonium hydroxide, salts thereof, and combinations thereof.

(10) In embodiment (10) is presented the composition of any one of embodiments (1)-(9), wherein the composition further comprises one or more water-miscible solvents.

(11) In embodiment (11) is presented the composition of embodiment (10), wherein the water-miscible solvent is selected from triethylene glycol monobutyl ether, propylene glycol n-butyl ether, propylene glycol monobutyl ether, dimethyl sulfoxide, diethylene glycol monophenyl ether, diethylene glycol monobutyl ether, and combinations thereof.

(12) In embodiment (12) is presented the composition of any one of embodiments (1)-(11), wherein the composition further comprises an amine compound selected from aminoethylethanolamine, N-methylaminoethanol, aminoethoxyethanol, dimethylaminoethoxyethanol, N-methyldiethanolamine, monoethanolamine (MEA), diethanolamine (DEA), triethanolamine (TEA), 1-amino-2-propanol, 2-amino-1-butanol, isobutanolamine, triethylenediamine, 4-(2-hydroxyethyl) morpholine (HEM), 2-amino-2-(hydroxymethyl)-1,3-propanediol, diglycolamine, diisopropanolamine, tris(hydroxymethyl)aminomethane, and combinations thereof.

(13) In embodiment (13) is presented the composition of any one of embodiments (1)-(12), wherein the composition further comprises an amino acid selected from arginine, histidine, lysine, aspartic acid, glutamic acid, serine, threonine, asparagine, glutamine, cysteine, glycine, proline, alanine, valine, isoleucine, leucine, methionine, phenylalanine, tyrosine, tryptophan, salts thereof, and combinations thereof.

(14) In embodiment (14) is presented the composition of embodiment (13), wherein the composition comprises an amino acid selected from arginine, histidine, lysine, salts thereof, and combinations thereof.

(15) In embodiment (15) is presented the composition of any one of embodiments (1)-(14), wherein the composition further comprises one or more water-dispersible or water-soluble polymers.

(16) In embodiment (16) is presented the composition of any one of embodiments (1)-(15), wherein the composition further comprises a pH adjustor and/or a biocide.

(17) In embodiment (17) is presented the composition of any one of embodiments (1)-(16), wherein the composition has a pH of about 1 to about 6.

(18) In embodiment (18) is presented the composition of any one of embodiments (1)-(17), wherein the composition has a pH of about 2 to about 5.

(19) In embodiment (19) is presented a method for removing residue from a surface of a microelectronic device substrate, the method comprising:
(i) contacting the surface of the microelectronic device substrate with a composition comprising:
   (a) water,
   (b) a sulfonated polymer, a sulfonated alkyl amine compound, or a combination thereof,
   (c) a chelating agent, and
   (d) an organic compound comprising a quaternary amine,
wherein the composition has a pH of less than about 7, and
(ii) removing at least a portion of the residue from the surface of the microelectronic device substrate.

(20) In embodiment (20) is presented the method of embodiment (19), wherein the sulfonated polymer comprises a monomer unit derived from a monomer selected from 2-acrylamido-2-methylpropane sulfonic acid, 2-methylacrylamido-2-methylpropane sulfonic acid, styrene sulfonic acid, vinyl sulfonic acid, 3-allyloxy-2-hydroxy-1-propanesulfonic acid, 2-sulfoethyl methacrylate, 2-sulfoethylacrylate, 3-sulfopropyl methacrylate, 3-sulfopropyl acrylate, salts thereof, and combinations thereof.

(21) In embodiment (21) is presented the method of embodiment (19) or embodiment (20), wherein the sulfonated polymer comprises a monomer unit derived from a monomer selected from 2-acrylamido-2-methylpropane sulfonic acid, styrene sulfonic acid, salts thereof, or a combination thereof.

(22) In embodiment (22) is presented the method of any one of embodiments (19)-(21), wherein the sulfonated polymer further comprises one or more additional monomer units derived from a (meth)acrylate monomer, a (meth)acrylamido monomer, a styrenic monomer, a vinylic monomer, or a combination thereof.

(23) In embodiment (23) is presented the method of any one of embodiments (19)-(21), wherein the sulfonated polymer is polystyrene sulfonic acid or a salt thereof.

(24) In embodiment (24) is presented the method of any one of embodiments (19)-(23), wherein the chelating agent comprises ethylenediamine tetraacetic acid (EDTA), hydroxyethylethylenediamine triacetic (HEDTA), cyclohexane diamine tetraacetic acid (CDTA), and diethylenetriamine pentaacetic acid (DETPA), hydroxyethylidene diphosphonic acid (HEDP), diethylenetriamine pentamethylene phosphonic acid, bis(hexamethylene)triaminepenta (methylenephosphonic) acid, nitrilotri(methylphosphonic acid), hexamethylenediamine-N,N,N′,N′-tetrakis(methylphosphonic acid), 2-phosphono-1,2,4-butane carboxylic acid, citric acid, ascorbic acid, picolinic acid, dipicolinic acid, salts thereof, or a combination thereof.

(25) In embodiment (25) is presented the method of any one of embodiments (19)-(24), wherein the chelating agent comprises hydroxyethylidene diphosphonic acid (HEDP), nitrilotri(methylphosphonic acid), citric acid, picolinic acid, dipicolinic acid, salts thereof, or a combination thereof.

(26) In embodiment (26) is presented the method of any one of embodiments (19)-(25), wherein the organic compound comprising a quaternary amine is selected from dimethyldiethylammnonium hydroxide, dimethyldiethylammnonium chloride, dimethyldiethylammnonium bromide, dimethyldiethylammnonium sulfate, dimethyldiethylammnonium methanesulfonate, dimethyldiethylammnonium phosphate, diallyldimethyl ammonium hydroxide, diallyldimethyl ammonium chloride, diallyldimethyl ammonium bromide, diallyldimethyl ammonium sulfate, diallyldimethyl ammonium methanesulfonate, diallyldimethyl ammonium phosphate, dimethallyldimethyl ammonium hydroxide, dimethallyldimethyl ammonium chloride, dimethallyldimethyl ammonium bromide, dimethallyldimethyl ammonium sulfate, dimethallyldimethyl ammonium methanesulfonate, dimethallyldimethyl ammonium phosphate, diethallyldimethyl ammonium hydroxide, diethallyldimethyl ammonium chloride, diethallyldimethyl ammonium bromide, diethallyldimethyl ammonium sulfate, diethallyldimethyl ammonium methanesulfonate, diethallyldimethyl ammonium phosphate, diallyl di(beta-hydroxyethyl) ammonium hydroxide, diallyl di(beta-hydroxyethyl) ammonium chloride, diallyl di(beta-hydroxyethyl) ammonium bromide, diallyl di(beta-hydroxyethyl) ammonium sulfate, diallyl di(beta-hydroxyethyl) ammonium methanesulfonate, diallyl di(beta-hydroxyethyl) ammonium phosphate, diallyl di(beta-ethoxyethyl) ammonium hydroxide, diallyl di(beta-ethoxyethyl) ammonium chloride, diallyl di(beta-ethoxyethyl) ammonium bromide, diallyl di(beta-ethoxyethyl) ammonium sulfate, diallyl di(beta-ethoxyethyl) ammonium methanesulfonate, diallyl di(beta-ethoxyethyl) ammonium phosphate, betaine, 3-trimethylammoniumpropanesulfonate, tetraethylammonium hydroxide, tetraethylammonium chloride, tetraethylammonium bromide, tetraethylammonium sulfate, tetraethylammonium methanesulfonate, tetraethylammonium phosphate, tetramethylammonium hydroxide, tetramethylammonium chloride, tetramethylammonium bromide, tetramethylammonium sulfate, tetramethylammonium methanesulfonate, tetramethylammonium phosphate, tetrapropylammonium hydroxide, tetrapropylammonium chloride, tetrapropylammonium bromide, tetrapropylammonium sulfate, tetrapropylammonium methanesulfonate, tetrapropylammonium phosphate, tetrabutylammonium hydroxide, tetrabutylammonium chloride, tetrabutylammonium bromide, tetrabutylammonium sulfate, tetrabutylammonium methanesulfonate, tetrabutylammonium phosphate, tributylmethylammonium hydroxide, tributylmethylammonium chloride, tributylmethylammonium bromide, tributylmethylammonium sulfate, tributylmethylammonium methanesulfonate, tributylmethylammonium phosphate, benzyltrimethylammonium hydroxide, benzyltrimethylammonium chloride, benzyltrimethylammonium bromide, benzyltrimethylammonium sulfate, benzyltrimethylammonium methanesulfonate, benzyltrimethylammonium phosphate, methyl(trishydroxyethyl)ammonium hydroxide, methyl(trishydroxyethyl)ammonium chloride, methyl(trishydroxyethyl)ammonium bromide, methyl(trishydroxyethyl)ammonium sulfate, methyl(trishydroxyethyl)ammonium methanesulfonate, methyl(trishydroxyethyl)ammonium phosphate, ethyltrimethylammonium hydroxide, ethyltrimethylammonium chloride, ethyltrimethylammonium bromide, ethyltrimethylammonium sulfate, ethyltrimethylammonium methanesulfonate, ethyltrimethylammonium phosphate, methyltriethylammonium hydroxide, methyltriethylammonium chloride, methyltriethylammonium bromide, methyltriethylammonium sulfate, methyltriethylammonium methanesulfonate, methyltriethylammonium phosphate, choline hydroxide, choline chloride, choline bromide, choline sulfate, choline methanesulfonate, choline phosphate, methyl tris (hydroxyethyl)ammonium hydroxide, methyl tris(hydroxyethyl)ammonium chloride, methyl tris(hydroxyethyl)ammonium bromide, methyl tris(hydroxyethyl)ammonium sulfate, methyl tris(hydroxyethyl)ammonium methanesulfonate, methyl tris(hydroxyethyl)ammonium phosphate, salts thereof, and combinations thereof.

(27) In embodiment (27) is presented the method of any one of embodiments (19)-(26), wherein the organic compound comprising a quaternary amine is selected from dimethyldiethylammnonium hydroxide, diallyldimethyl ammonium chloride, betaine, 3-trimethylammoniumpropanesulfonate, tetraethylammonium hydroxide (TEAH), tetrabutylammonium hydroxide (TBAH), choline hydroxide, methyl tris (hydroxyethyl) ammonium hydroxide, salts thereof, and combinations thereof.

(28) In embodiment (28) is presented the method of any one of embodiments (19)-(27), wherein the composition further comprises one or more water-miscible solvents.

(29) In embodiment (29) is presented the method of embodiment (28), wherein the water-miscible solvent is selected from triethylene glycol monobutyl ether, propylene glycol n-butyl ether, propylene glycol monobutyl ether, dimethyl sulfoxide, diethylene glycol monophenyl ether, diethylene glycol monobutyl ether, and combinations thereof.

(30) In embodiment (30) is presented the method of any one of embodiments (19)-(29), wherein the composition further comprises an amine compound selected from aminoethylethanolamine, N-methylaminoethanol, aminoethoxyethanol, dimethylaminoethoxyethanol, N-methyldiethanolamine, monoethanolamine (MEA), diethanolamine (DEA), triethanolamine (TEA), 1-amino-2-propanol, 2-amino-1-butanol, isobutanolamine, triethylenediamine, 4-(2-hydroxyethyl) morpholine (HEM), 2-amino-2-(hydroxymethyl)-1,3-propanediol, diglycolamine, diisopropanolamine, tris(hydroxymethyl)aminomethane, and combinations thereof.

(31) In embodiment (31) is presented the method of any one of embodiments (19)-(30), wherein the composition further comprises an amino acid selected from arginine, histidine, lysine, aspartic acid, glutamic acid, serine, threonine, asparagine, glutamine, cysteine, glycine, proline, alanine, valine, isoleucine, leucine, methionine, phenylalanine, tyrosine, tryptophan, salts thereof, and combinations thereof.

(32) In embodiment (32) is presented the method of embodiment (31), wherein the composition comprises an amino acid selected from arginine, histidine, lysine, salts thereof, and combinations thereof.

(33) In embodiment (33) is presented the method of any one of embodiments (19)-(32), wherein the composition further comprises one or more water-dispersible or water-soluble polymers.

(34) In embodiment (34) is presented the method of any one of embodiments (19)-(33), wherein the composition further comprises a pH adjustor and/or a biocide.

(35) In embodiment (35) is presented the method of any one of embodiments (19)-(34), wherein the composition has a pH of about 1 to about 6.

(36) In embodiment (36) is presented the method of any one of embodiments (19)-(35), wherein the composition has a pH of about 2 to about 5.

(37) In embodiment (37) is presented the method of any one of embodiments (19)-(36), wherein the microelectronic device substrate comprises molybdenum layer on a surface thereof.

(38) In embodiment (38) is presented the method of any one of embodiments (19)-(37), wherein the microelectronic device substrate comprises tungsten layer on a surface thereof.

### EXAMPLES

These following examples further illustrate the invention but, of course, should not be construed as in any way limiting its scope.

### Example 1

This example demonstrates the effect of a chelating agent (e.g., citric acid and hydroxyethylidene diphosphonic acid (HEDP)), an amine compound (e.g., monoethanolamine), a sulfonated polymer, a sulfonated alkyl amine compound, or a combination thereof (e.g., polystyrene sulfonic acid (PSSA)), an organic compound comprising a quaternary amine (e.g., betaine), and a water-miscible solvent (triethylene glycol monobutyl ether (e.g., TEGMBE)) on the cleaning performance of a composition prepared according to the invention.

Aqueous Cleaning Compositions 1A-1G were prepared using citric acid (aqueous 32 wt. %), hydroxyethylidene diphosphonic acid (HEDP) (aqueous 60 wt. %), monoethanolamine, polystyrene sulfonic acid (PSSA) (aqueous 32 wt. %), betaine, and triethylene glycol monobutyl ether (TEGMBE) in the amounts set forth in Table 1, and the resulting solutions were adjusted to a pH of 2.22 using nitric acid.

TABLE 1
Cleaning Compositions 1A-1G

| | 32% | | | | | |
|---|---|---|---|---|---|---|
| | Citric | | 60% | 32% | | |
| Cleaning | acid | Monoethanolamine | HEDP | PSSA | Betaine | TEGMBE |
| Composition | (wt. %) | (wt. %) | (wt. %) | (wt. %) | (wt. %) | (wt. %) |
| 1A | 3.13 | 2.5 | 5 | 1.56 | 0.502 | 2.522 |
| (Inventive) | | | | | | |
| 1B | — | 2.5 | 5 | 1.56 | 0.502 | 2.522 |
| (Inventive) | | | | | | |
| 1C | 3.13 | — | 5 | 1.56 | 0.502 | 2.522 |
| (Inventive) | | | | | | |
| 1D | 3.13 | 2.5 | — | 1.56 | 0.502 | 2.522 |
| (Inventive) | | | | | | |
| 1E | 3.13 | 2.5 | 5 | — | 0.502 | 2.522 |
| (Inventive) | | | | | | |
| 1F | 3.13 | 2.5 | 5 | 1.56 | — | 2.522 |
| (Inventive) | | | | | | |
| 1G | 3.13 | 2.5 | 5 | 1.56 | 0.502 | — |
| (Inventive) | | | | | | |

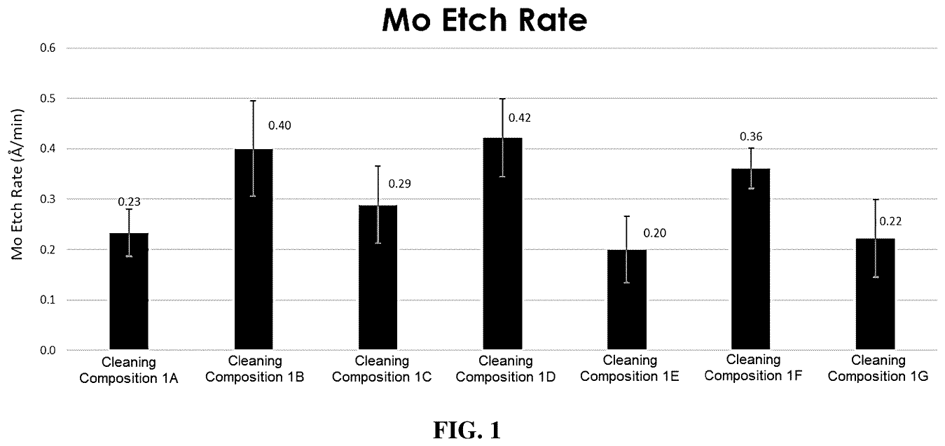

Cleaning Compositions 1A-1G were diluted 60-fold with deionized water at the point-of-use and used to clean polished 300 mm wafers containing a physical vapor deposition (PVD) molybdenum layer. X-ray fluorescence (XRF) was employed to determine the molybdenum film thicknesses before and after a post chemical-mechanical planarization (CMP) cleaning process. The processing conditions included a 15-minute cleaning at 30° C. and 500 rpm, followed by a 2-minute deionized water rinse and nitrogen (N₂) drying. The molybdenum etch rate (Å/min) was calculated using the change in film thickness as a function of time, and the results are set forth in FIG. 1.

As is apparent from the results set forth in FIG. 1, removing the chelating agent (i.e., citric acid or hydroxyethylidene diphosphonic acid (HEDP)) or the organic compound comprising a quaternary amine (i.e., betaine) from the cleaning composition had a negative impact on the molybdenum (Mo) etch rate, as evidenced by an increased Mo etch rate for Cleaning Compositions 1B, 1D, and 1F as compared to Cleaning Composition 1A.

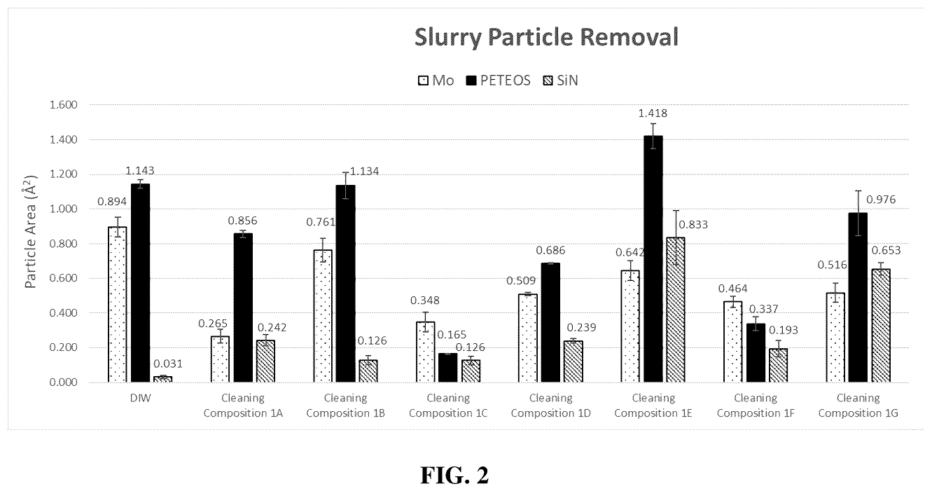

Scanning electron microscope (SEM) was used to image slurry particles remaining on wafer coupons containing physical vapor deposition (PVD) molybdenum, plasma enhanced tetraethylorthosilicate (PETEOS), or silicon nitride (SiN) surfaces that were previously polished on a benchtop polisher with a molybdenum polishing silica-based slurry, and subsequently cleaned with Cleaning Compositions 1A-1G in conjunction with Entegris PLANACORE™ Brushes, and “particle surface area” was calculated as a measure of slurry cleaning efficiency. A lower remaining “particle surface area” indicates better cleaning efficiency of a cleaning composition. The results of the remaining particle surface area of deionized water (control) and Cleaning Compositions 1A-1G for the molybdenum, PETEOS, and SiN surfaces are set forth in FIG. 2.

As is apparent from the results set forth in FIG. 2, removing the chelating agent (i.e., citric acid), the sulfonated polymer (i.e., PSSA), or the water-miscible solvent (TEGMBE) from the cleaning composition had a negative impact on the slurry cleaning efficiency, as evidenced by an increased particle surface area for Cleaning Compositions 1B, 1E, and 1G as compared to Cleaning Composition 1A.

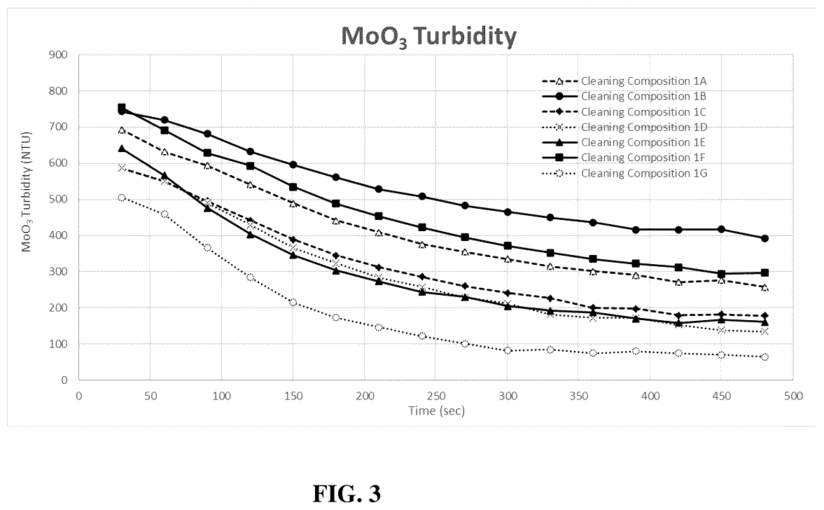

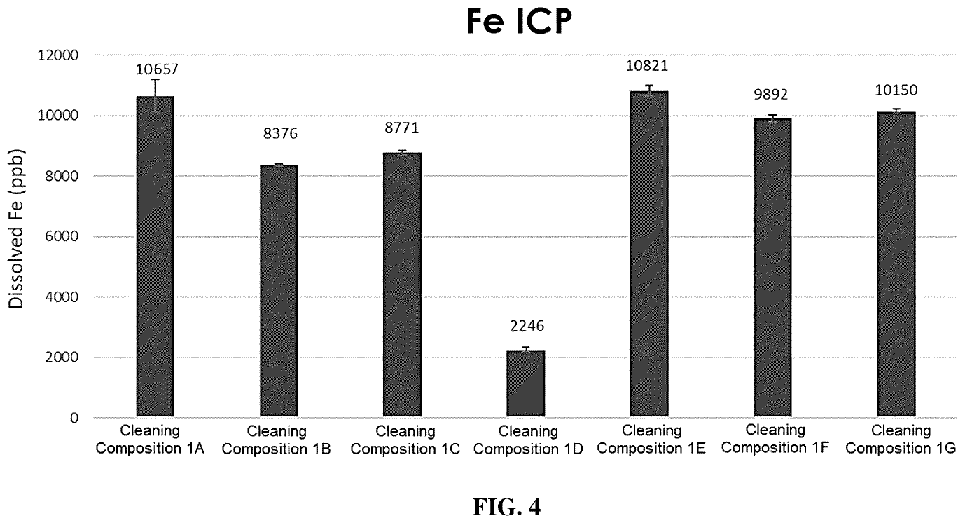

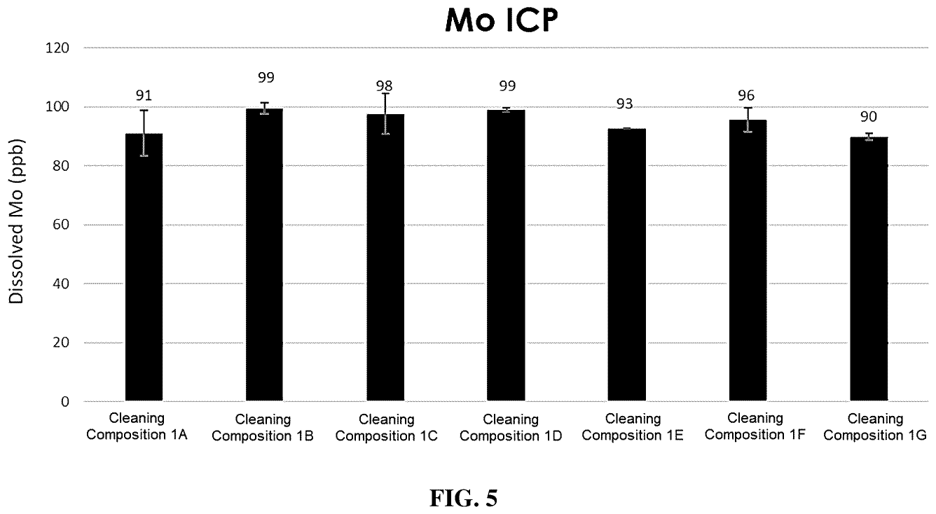

After the chemical-mechanical planarization (CMP) cleaning process, the resulting solution was analyzed to determine the MoO₃ turbidity using light transmittance, and the dissolved molybdenum and dissolved iron concentrations using inductively coupled plasma mass spectrometry. The MoO₃ turbidity results are set forth in FIG. 3, the dissolved iron results are set forth in FIG. 4, and the dissolved molybdenum results are set forth in FIG. 5.

As is apparent from the results set forth in FIG. 3, removing the chelating agent (i.e., citric acid or hydroxyethylidene diphosphonic acid (HEDP)), the sulfonated polymer (i.e., PSSA), or the water-miscible solvent (TEGMBE) had a negative impact on the ability of the cleaning composition to remove MoO₃ from the surface of the molybdenum film, as evidenced by a decreased MoO₃ turbidity of Cleaning Compositions 1B, 1D, 1E, and 1G post cleaning process, as compared to Cleaning Composition 1A. In addition, FIG. 4 shows that removing the chelating agent (i.e., citric acid or hydroxyethylidene diphosphonic acid (HEDP)) or the amine compound (i.e., monoethanolamine) had a negative impact on the ability of the cleaning composition to remove iron from the surface of the molybdenum film, as evidenced by a decreased dissolved iron concentration of Cleaning Compositions 1B, 1C, and 1D post cleaning process, as compared to Cleaning Composition 1A.

In contrast, FIG. 5 shows that the dissolved molybdenum concentration remained consistently low for all of Cleaning Compositions 1A-1G post cleaning process, indicating that Cleaning Compositions 1A-1G desirably resulted in minimal molybdenum etching.

### Example 2

This example demonstrates the effect on Tafel open circuit potential (OCP), exhibited by cleaning compositions prepared according to the invention.

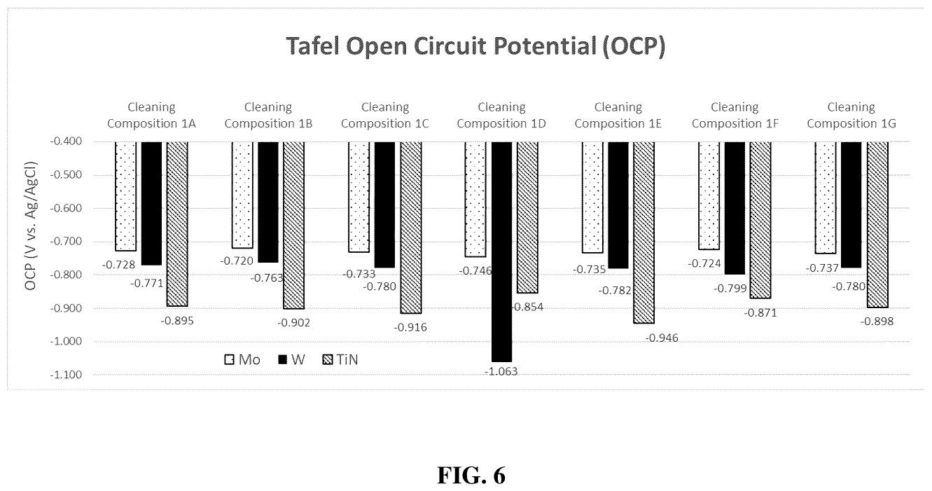

Cleaning Compositions 1A-1G, as described in Example 1, were used to measure Tafel curves of molybdenum, tungsten, and titanium nitride substrates. Open circuit potential (OCP) values were determined as the voltage where substrate current changes from negative to positive values during a potentiodynamic scanning. The results are set forth in FIG. 6.

As is apparent from the results set forth in FIG. 6, removing the chelating agent (i.e., hydroxyethylidene diphosphonic acid (HEDP)) from the cleaning composition increased the OCP gaps between molybdenum and tungsten substrates leading to galvanic corrosion enhancement, as evidenced by Cleaning Composition 1D as compared to Cleaning Composition 1A.

### Example 3

This example demonstrates the effect of a sulfonated polymer (polystyrene sulfonic acid (PSSA)) on the cleaning performance of a composition prepared according to the invention.

Aqueous Cleaning Compositions 2A-2D were prepared as follows:
Cleaning Composition 2A (Comparative)—2% aqueous ammonia (NH₃);
Cleaning Composition 2B (Comparative)—4.42% choline hydroxide (CAS #123-41-1), 1.92% citric acid (CAS #77-92-9), 2.4% ascorbic acid (CAS #50-81-7), 0.08% poly(acrylic acid) (CAS #9003-01-04), and a pH 6;
Cleaning Composition 2C (Inventive)—1% citric acid (CAS #77-92-9), 3% HEDP (CAS #2809-21-4), 2.522% triethylene glycol monobutyl ether (TEGMBE) (CAS #143-22-6), 2.5% MEA (CAS #141-43-5), 0.5% poly(4-styrenesulfonic acid) (CAS #28210-41-5), 0.1757% betaine (CAS #107-43-7), 1.3722% nitric acid (CAS #7697-37-2), and a pH 2.3; and
Cleaning Composition 2D (Inventive)—0.5% poly(acrylic acid) (CAS #9003-01-04), 6% sorbitol (CAS #50-70-4), 4.5% citric acid (CAS #77-92-9), 0.5% poly(4-styrenesulfonic acid) (CAS #28210-41-5), 0.8% 3-amino-4-octanol (CAS #1001354-72-8), 4.5% choline hydroxide (CAS #123-41-1), and a pH of 4.5.

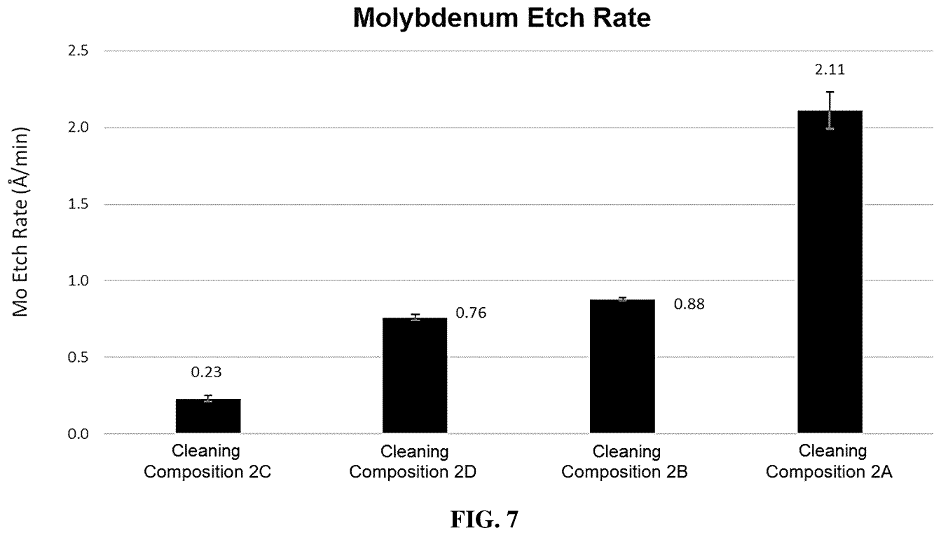

Cleaning Compositions 2A-2D were diluted 60-fold with deionized water at the point-of-use and used to clean polished 300 mm wafers containing a physical vapor deposition (PVD) molybdenum layer. X-ray fluorescence (XRF) was employed to determine the molybdenum film thicknesses before and after a post chemical-mechanical planarization (CMP) cleaning process. The processing conditions included a 15-minute cleaning at 30° C. and 500 rpm, followed by a 2-minute deionized water rinse and nitrogen (N2) drying. The molybdenum etch rate (Å/min) was calculated using the change in film thickness as a function of time, and the results are set forth in FIG. 7.

As is apparent from the results set forth in FIG. 7, Inventive Polishing Compositions 2C and 2D exhibited a significantly lower molybdenum etch rate than Comparative Polishing Composition 2A consisting of aqueous ammonia. In addition, FIG. 7 shows that Inventive Polishing Compositions 2C and 2D, containing a sulfonated polymer (polystyrene sulfonic acid (PSSA)), exhibited a lower molybdenum etch rate than Comparative Polishing Composition 2B, which did not contain a sulfonated polymer.

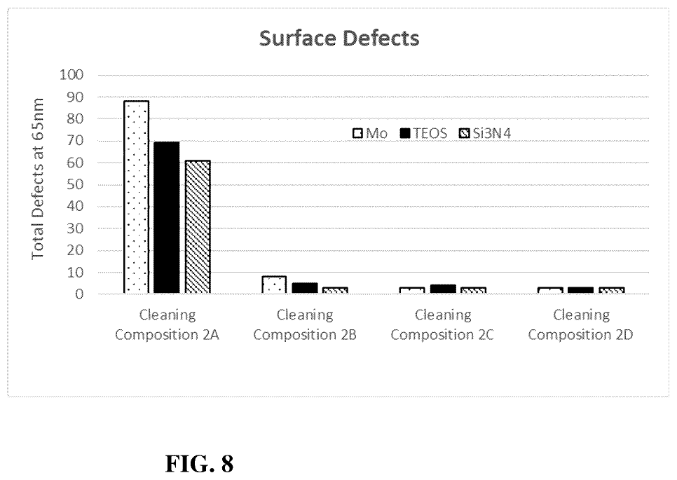

Scanning electron microscope (SEM) was used to image surface defects remaining on 300 mm wafers containing physical vapor deposition (PVD) molybdenum, plasma enhanced tetraethylorthosilicate (PETEOS), or SiN surfaces that were previously polished on a 300 mm polisher with a molybdenum polishing silica-based slurry, and subsequently cleaned with Cleaning Compositions 2A-2D in conjunction with Entegris PLANACORE™ Brushes. The 300 Reflexion data was collected with SP3, and SEMVISION™ defect review was conducted to quantify the number of surface defects. The results of the surface defect review for Cleaning Compositions 2A-2D for the molybdenum, PETEOS, and SiN surfaces are set forth in FIG. 8.

As is apparent from the results set forth in FIG. 8, Inventive Polishing Compositions 2C and 2D exhibited significantly fewer surface defects than Comparative Polishing Composition 2A consisting of aqueous ammonia. In addition, FIG. 8 shows that Inventive Polishing Compositions 2C and 2D, containing a sulfonated polymer (polystyrene sulfonic acid (PSSA)), exhibited fewer surface defects, on average, than Comparative Polishing Composition 2B, which did not contain a sulfonated polymer.

### Example 4

This example demonstrates the effect of a sulfonated alkyl amine compound (4-(2-hydroxyethyl)-1-piperazineethane sulfonic acid (HEPES)) on the cleaning performance of a composition prepared according to the invention.

Aqueous Cleaning Compositions 3A-3C were prepared as follows:
Cleaning Composition 3A (Comparative)—1% citric acid (CAS #77-92-9), 4.95% HEDP (CAS #2809-21-4), 2.522% triethylene glycol monobutyl ether (TEGMBE) (CAS #143-22-6), 2.5% MEA (CAS #141-43-5), 0.1757% betaine (CAS #107-43-7), 1.3722% nitric acid (CAS #7697-37-2), and a pH 2.3;
Cleaning Composition 3B (Inventive)—1% citric acid (CAS #77-92-9), 4.95% HEDP (CAS #2809-21-4), 2.522% triethylene glycol monobutyl ether (TEGMBE) (CAS #143-22-6), 2.5% MEA (CAS #141-43-5), 0.5% poly(4-styrenesulfonic acid) (CAS #28210-41-5), 0.1757% betaine (CAS #107-43-7), 1.3722% nitric acid (CAS #7697-37-2), and a pH 2.3; and
Cleaning Composition 3C (Inventive)—1% citric acid (CAS #77-92-9), 4.95% HEDP (CAS #2809-21-4), 2.522% triethylene glycol monobutyl ether (TEGMBE) (CAS #143-22-6), 2.5% MEA (CAS #141-43-5), 0.114% HEPES (CAS #7365-45-9), 0.1757% betaine (CAS #107-43-7), 1.3722% nitric acid (CAS #7697-37-2), and a pH 2.3.

Scanning electron microscope (SEM) was used to image slurry particles remaining on wafer coupons containing physical vapor deposition (PVD) molybdenum, plasma enhanced tetraethylorthosilicate (PETEOS), or silicon nitride (SiN) surfaces that were previously polished on a benchtop polisher with a molybdenum polishing silica-based slurry, and subsequently cleaned with Cleaning Compositions 3A-3C in conjunction with Entegris PLANACORE™ Brushes, and “particle surface area” was calculated as a measure of slurry cleaning efficiency. A lower remaining “particle surface area” indicates better cleaning efficiency of a cleaning composition.

The results of the remaining particle surface area show that Cleaning Composition 3C, containing a sulfonated alkyl amine compound (4-(2-hydroxyethyl)-1-piperazineethane sulfonic acid (HEPES)) exhibited improved cleaning performance relative to Cleaning Composition 3A, which did not contain a sulfonated polymer or a sulfonated alkyl amine compound, and Cleaning Composition 3B, which contained a sulfonated polymer but did not contain a sulfonated alkyl amine compound.

### Example 5

This example demonstrates the effect of an organic compound comprising a quaternary amine (e.g., diallyldimethyl ammonium chloride (DADMAC), tetraethylammonium hydroxide (TEAH), choline hydroxide, and TEA) on the cleaning performance of a cleaning composition.

Aqueous Cleaning Compositions 4A-4F were prepared using polystyrene sulfonic acid (PSSA) and an organic compound comprising a quaternary amine, as set forth in Table 2, and the resulting solutions were adjusted to a pH of 4.7 using potassium hydroxide.

TABLE 2
Cleaning Compositions 4A-4F

| Cleaning Composition | PSSA (wt. %) | Quaternary Amine |
|---|---|---|
| 4A | 0.1 | None |
| 4B | 0 | DADMAC |
| 4C | 0 | Choline hydroxide |
| 4D | 0.1 | DADMAC |
| 4E | 0.1 | Choline hydroxide |
| 4F | 0.1 | tetraethylammonium |
| | | hydroxide (TEAH) |

Scanning electron microscope (SEM) was used to image slurry particles remaining on wafer coupons containing plasma enhanced tetraethylorthosilicate (PETEOS), that were previously polished on a benchtop polisher with a tungsten polishing silica-based slurry, and subsequently cleaned with Cleaning Compositions 4A-4F in conjunction with Entegris PLANACORE™ Brushes, and “particle surface area” was calculated as a measure of slurry cleaning efficiency. A lower remaining “particle surface area” indicates better cleaning efficiency of a cleaning composition. The results of the remaining particle surface area of Cleaning Compositions 4A-4F on PETEOS are set forth in Table 3. Additionally, cleaning efficiencies of Cleaning Compositions 4A-4F were tested by cleaning plasma enhanced tetraethylorthosilicate (PETEOS) wafer coupons that were previously polished on a benchtop polisher along with tungsten coupons with a tungsten polishing silica-based slurry. In other words, the cleanability of Cleaning Compositions 4A-4F on a TEOS surface, when tungsten polishing waste was present, was analyzed.

TABLE 3
Particle Surface Area of Cleaning Compositions 4A-4F

| Cleaning | % particle surface | % particle surface area on PETEOS |
|---|---|---|
| Composition | area on PETEOS | when polished with tungsten waste |
| 4A | 0.89 | 3 |
| 4B | 14.6 | 0.95 |
| 4C | 12.1 | 11.9 |
| 4D | 0.56 | 1.82 |
| 4E | 1.5 | 1.86 |
| 4F | 1.34 | 3.73 |

As is apparent from the results set forth in Table 3, Cleaning Compositions 4D-4F, containing a sulfonated polymer (i.e., PSSA) and an organic compound comprising a quaternary amine (i.e., diallyldimethyl ammonium chloride (DADMAC), tetraethylammonium hydroxide (TEAH), or choline hydroxide), exhibited the lowest particle surface area on TEOS coupons. In other words, the presence of the organic compound comprising a quaternary amine in the cleaning composition helped reduce the adverse effects caused by tungsten polishing waste.

### Example 6

This example demonstrates the effect of concentration of an organic compound comprising a quaternary amine (e.g., diallyldimethyl ammonium chloride (DADMAC) and a sulfonated polymer (polystyrene sulfonic acid (PSSA)) on the cleaning performance of a cleaning composition.

Aqueous Cleaning Compositions 5A-5E were prepared using polystyrene sulfonic acid (PSSA), diallyldimethyl ammonium chloride (DADMAC), and hydroxyethylidene diphosphonic acid (HEDP) in the amounts set forth in Table 4. The resulting solutions were adjusted to a pH of 4.7 using potassium hydroxide.

TABLE 4
Cleaning Compositions 5A-5E

| Cleaning | PSSA | DADMAC | HEDP |
|---|---|---|---|
| Composition | (wt. %) | (wt. %) | (wt. %) |
| 5A | 0.3 | 0.3 | 1 |
| (Inventive) | | | |
| 5B | 1 | 1 | 1 |
| (Inventive) | | | |
| 5C | 1 | 0.3 | 1 |
| (Inventive) | | | |
| 5D | 0.3 | 1 | 1 |
| (Inventive) | | | |
| 5E | 0.65 | 0.65 | 1 |
| (Inventive) | | | |

Cleaning Compositions 5A-5E were diluted 60-fold with deionized water at the point-of-use and used to clean polished 300 mm wafers containing plasma enhanced tetraethylorthosilicate (PETEOS) on REFLEXION™. Cleaned wafers were inspected using SURFSCAN™ SP7XP wafer defect inspection system (manufacture KLA Corporation) and further defects were classified using SEMVISION™ G7 Defect Analysis (manufacture Applied Materials, Inc.). The results for the number of slurry particle and residue defects at 50 nm are set forth in Table 5.

TABLE 5
Slurry Particle and Residue Defects at
50 nm for Cleaning Compositions 5A-5E

| Cleaning | # of Particle Defects | # of Residue Defects |
|---|---|---|
| Composition | at 50 nm | at 50 nm |
| 5A | 45 | 8 |
| (Inventive) | | |
| 5B | 64 | 4 |
| (Inventive) | | |
| 5C | 23 | 22 |
| (Inventive) | | |
| 5D | 19 | 6 |
| (Inventive) | | |
| 5E | 15 | 4 |
| (Inventive) | | |

As is apparent from the results set forth in Table 5, Cleaning Composition 5E, containing 0.65% of the sulfonated polymer (i.e., PSSA) and 0.65% of the organic compound comprising a quaternary amine (i.e., DADMAC), exhibited the fewest particle and residue defects on the PETEOS wafer surface.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A composition comprising:
(a) water,
(b) a sulfonated polymer, a sulfonated alkyl amine compound, or a combination thereof,
(c) a chelating agent, and
(d) an organic compound comprising a quaternary amine,
wherein the composition has a pH of less than about 7.

2. The composition of claim 1, wherein the sulfonated polymer comprises a monomer unit derived from a monomer selected from 2-acrylamido-2-methylpropane sulfonic acid, 2-methylacrylamido-2-methylpropane sulfonic acid, styrene sulfonic acid, vinyl sulfonic acid, 3-allyloxy-2-hydroxy-1-propanesulfonic acid, 2-sulfoethyl methacrylate, 2-sulfoethylacrylate, 3-sulfopropyl methacrylate, 3-sulfopropyl acrylate, salts thereof, and combinations thereof.

3. The composition of claim 1, wherein the sulfonated polymer is polystyrene sulfonic acid or a salt thereof.

4. The composition of claim 1, wherein the chelating agent is selected from ethylenediamine tetraacetic acid (EDTA), hydroxyethylethylenediamine triacetic (HEDTA), cyclohexane diamine tetraacetic acid (CDTA), and diethylenetriamine pentaacetic acid (DETPA), hydroxyethylidene diphosphonic acid (HEDP), diethylenetriamine pentamethylene phosphonic acid, bis(hexamethylene)triaminepenta(methylenephosphonic) acid, nitrilotri(methylphosphonic acid), hexamethylenediamine-N,N,N′,N′-tetrakis(methylphosphonic acid), 2-phosphono-1,2,4-butane carboxylic acid, citric acid, ascorbic acid, picolinic acid, dipicolinic acid, salts thereof, and combinations thereof.

5. The composition of claim 4, wherein the chelating agent is selected from hydroxyethylidene diphosphonic acid (HEDP), nitrilotri(methylphosphonic acid), citric acid, picolinic acid, dipicolinic acid, salts thereof, and combinations thereof.

6. The composition of claim 1, wherein the organic compound comprising a quaternary amine is selected from dimethyldiethylammnonium hydroxide, dimethyldiethylammnonium chloride, dimethyldiethylammnonium bromide, dimethyldiethylammnonium sulfate, dimethyldiethylammnonium methanesulfonate, dimethyldiethylammnonium phosphate, diallyldimethyl ammonium hydroxide, diallyldimethyl ammonium chloride, diallyldimethyl ammonium bromide, diallyldimethyl ammonium sulfate, diallyldimethyl ammonium methanesulfonate, diallyldimethyl ammonium phosphate, dimethallyldimethyl ammonium hydroxide, dimethallyldimethyl ammonium chloride, dimethallyldimethyl ammonium bromide, dimethallyldimethyl ammonium sulfate, dimethallyldimethyl ammonium methanesulfonate, dimethallyldimethyl ammonium phosphate, diethallyldimethyl ammonium hydroxide, diethallyldimethyl ammonium chloride, diethallyldimethyl ammonium bromide, diethallyldimethyl ammonium sulfate, diethallyldimethyl ammonium methanesulfonate, diethallyldimethyl ammonium phosphate, diallyl di(beta-hydroxyethyl) ammonium hydroxide, diallyl di(beta-hydroxyethyl) ammonium chloride, diallyl di(beta-hydroxyethyl) ammonium bromide, diallyl di(beta-hydroxyethyl) ammonium sulfate, diallyl di(beta-hydroxyethyl) ammonium methanesulfonate, diallyl di(beta-hydroxyethyl) ammonium phosphate, diallyl di(beta-ethoxyethyl) ammonium hydroxide, diallyl di(beta-ethoxyethyl) ammonium chloride, diallyl di(beta-ethoxyethyl) ammonium bromide, diallyl di(beta-ethoxyethyl) ammonium sulfate, diallyl di(beta-ethoxyethyl) ammonium methanesulfonate, diallyl di(beta-ethoxyethyl) ammonium phosphate, betaine, 3-trimethylammoniumpropanesulfonate, tetraethylammonium hydroxide, tetraethylammonium chloride, tetraethylammonium bromide, tetraethylammonium sulfate, tetraethylammonium methanesulfonate, tetraethylammonium phosphate, tetramethylammonium hydroxide, tetramethylammonium chloride, tetramethylammonium bromide, tetramethylammonium sulfate, tetramethylammonium methanesulfonate, tetramethylammonium phosphate, tetrapropylammonium hydroxide, tetrapropylammonium chloride, tetrapropylammonium bromide, tetrapropylammonium sulfate, tetrapropylammonium methanesulfonate, tetrapropylammonium phosphate, tetrabutylammonium hydroxide, tetrabutylammonium chloride, tetrabutylammonium bromide, tetrabutylammonium sulfate, tetrabutylammonium methanesulfonate, tetrabutylammonium phosphate, tributylmethylammonium hydroxide, tributylmethylammonium chloride, tributylmethylammonium bromide, tributylmethylammonium sulfate, tributylmethylammonium methanesulfonate, tributylmethylammonium phosphate, benzyltrimethylammonium hydroxide, benzyltrimethylammonium chloride, benzyltrimethylammonium bromide, benzyltrimethylammonium sulfate, benzyltrimethylammonium methanesulfonate, benzyltrimethylammonium phosphate, methyl(trishydroxyethyl)ammonium hydroxide, methyl(trishydroxyethyl)ammonium chloride, methyl(trishydroxyethyl)ammonium bromide, methyl(trishydroxyethyl)ammonium sulfate, methyl(trishydroxyethyl)ammonium methanesulfonate, methyl(trishydroxyethyl)ammonium phosphate, ethyltrimethylammonium hydroxide, ethyltrimethylammonium chloride, ethyltrimethylammonium bromide, ethyltrimethylammonium sulfate, ethyltrimethylammonium methanesulfonate, ethyltrimethylammonium phosphate, methyltriethylammonium hydroxide, methyltriethylammonium chloride, methyltriethylammonium bromide, methyltriethylammonium sulfate, methyltriethylammonium methanesulfonate, methyltriethylammonium phosphate, choline hydroxide, choline chloride, choline bromide, choline sulfate, choline methanesulfonate, choline phosphate, methyl tris (hydroxyethyl)ammonium hydroxide, methyl tris(hydroxyethyl)ammonium chloride, methyl tris(hydroxyethyl)ammonium bromide, methyl tris(hydroxyethyl)ammonium sulfate, methyl tris(hydroxyethyl)ammonium methanesulfonate, methyl tris(hydroxyethyl)ammonium phosphate, salts thereof, and combinations thereof.

7. The composition of claim 6, wherein the organic compound comprising a quaternary amine is selected from dimethyldiethylammnonium hydroxide, diallyldimethyl ammonium chloride, betaine, 3-trimethylammoniumpropanesulfonate, tetraethylammonium hydroxide (TEAH), tetrabutylammonium hydroxide (TBAH), choline hydroxide, methyl tris (hydroxyethyl) ammonium hydroxide, salts thereof, and combinations thereof.

8. The composition of claim 1, wherein the composition further comprises one or more water-miscible solvents, wherein the water-miscible solvent is selected from triethylene glycol monobutyl ether, propylene glycol n-butyl ether, propylene glycol monobutyl ether, dimethyl sulfoxide, diethylene glycol monophenyl ether, diethylene glycol monobutyl ether, and combinations thereof.

9. The composition of claim 1, wherein the composition further comprises an amine compound selected from aminoethylethanolamine, N-methylaminoethanol, aminoethoxyethanol, dimethylaminoethoxyethanol, N-methyldiethanolamine, monoethanolamine (MEA), diethanolamine (DEA), triethanolamine (TEA), 1-amino-2-propanol, 2-amino-1-butanol, isobutanolamine, triethylenediamine, 4-(2-hydroxyethyl)morpholine (HEM), 2-amino-2-(hydroxymethyl)-1,3-propanediol, diglycolamine, diisopropanolamine, tris(hydroxymethyl)aminomethane, and combinations thereof.

10. The composition of claim 1, wherein the composition further comprises an amino acid selected from arginine, histidine, lysine, aspartic acid, glutamic acid, serine, threonine, asparagine, glutamine, cysteine, glycine, proline, alanine, valine, isoleucine, leucine, methionine, phenylalanine, tyrosine, tryptophan, salts thereof, and combinations thereof.

11. The composition of claim 1, wherein the composition has a pH of about 1 to about 6.

12. A method for removing residue from a surface of a microelectronic device substrate, the method comprising:
(i) contacting the surface of the microelectronic device substrate with a composition comprising:
(a) water,
(b) a sulfonated polymer, a sulfonated alkyl amine compound, or a combination thereof,
(c) a chelating agent, and
(d) an organic compound comprising a quaternary amine,
wherein the composition has a pH of less than about 7, and
(ii) removing at least a portion of the residue from the surface of the microelectronic device substrate.

13. The method of claim 12, wherein the sulfonated polymer comprises a monomer unit derived from a monomer selected from 2-acrylamido-2-methylpropane sulfonic acid, 2-methylacrylamido-2-methylpropane sulfonic acid, styrene sulfonic acid, vinyl sulfonic acid, 3-allyloxy-2-hydroxy-1-propanesulfonic acid, 2-sulfoethyl methacrylate, 2-sulfoethylacrylate, 3-sulfopropyl methacrylate, 3-sulfopropyl acrylate, salts thereof, and combinations thereof.

14. The method of claim 12, wherein the sulfonated polymer is polystyrene sulfonic acid or a salt thereof.

15. The method of claim 12, wherein the chelating agent is selected from ethylenediamine tetraacetic acid (EDTA), hydroxyethylethylenediamine triacetic (HEDTA), cyclohexane diamine tetraacetic acid (CDTA), and diethylenetriamine pentaacetic acid (DETPA), hydroxyethylidene diphosphonic acid (HEDP), diethylenetriamine pentamethylene phosphonic acid, bis(hexamethylene)triaminepenta(methylenephosphonic) acid, nitrilotri(methylphosphonic acid), hexamethylenediamine-N,N,N′,N′-tetrakis(methylphosphonic acid), 2-phosphono-1,2,4-butane carboxylic acid, citric acid, ascorbic acid, picolinic acid, dipicolinic acid, salts thereof, and combinations thereof.

16. The method of claim 12, wherein the organic compound comprising a quaternary amine is selected from dimethyldiethylammnonium hydroxide, dimethyldiethylammnonium chloride, dimethyldiethylammnonium bromide, dimethyldiethylammnonium sulfate, dimethyldiethylammonium methanesulfonate, dimethyldiethylammnonium phosphate, diallyldimethyl ammonium hydroxide, diallyldimethyl ammonium chloride, diallyldimethyl ammonium bromide, diallyldimethyl ammonium sulfate, diallyldimethyl ammonium methanesulfonate, diallyldimethyl ammonium phosphate, dimethallyldimethyl ammonium hydroxide, dimethallyldimethyl ammonium chloride, dimethallyldimethyl ammonium bromide, dimethallyldimethyl ammonium sulfate, dimethallyldimethyl ammonium methanesulfonate, dimethallyldimethyl ammonium phosphate, diethallyldimethyl ammonium hydroxide, diethallyldimethyl ammonium chloride, diethallyldimethyl ammonium bromide, diethallyldimethyl ammonium sulfate, diethallyldimethyl ammonium methanesulfonate, diethallyldimethyl ammonium phosphate, diallyl di(beta-hydroxyethyl) ammonium hydroxide, diallyl di(beta-hydroxyethyl) ammonium chloride, diallyl di(beta-hydroxyethyl) ammonium bromide, diallyl di(beta-hydroxyethyl) ammonium sulfate, diallyl di(beta-hydroxyethyl) ammonium methanesulfonate, diallyl di(beta-hydroxyethyl) ammonium phosphate, diallyl di(beta-ethoxyethyl) ammonium hydroxide, diallyl di(beta-ethoxyethyl) ammonium chloride, diallyl di(beta-ethoxyethyl) ammonium bromide, diallyl di(beta-ethoxyethyl) ammonium sulfate, diallyl di(beta-ethoxyethyl) ammonium methanesulfonate, diallyl di(beta-ethoxyethyl) ammonium phosphate, betaine, 3-trimethylammoniumpropanesulfonate, tetraethylammonium hydroxide, tetraethylammonium chloride, tetraethylammonium bromide, tetraethylammonium sulfate, tetraethylammonium methanesulfonate, tetraethylammonium phosphate, tetramethylammonium hydroxide, tetramethylammonium chloride, tetramethylammonium bromide, tetramethylammonium sulfate, tetramethylammonium methanesulfonate, tetramethylammonium phosphate, tetrapropylammonium hydroxide, tetrapropylammonium chloride, tetrapropylammonium bromide, tetrapropylammonium sulfate, tetrapropylammonium methanesulfonate, tetrapropylammonium phosphate, tetrabutylammonium hydroxide, tetrabutylammonium chloride, tetrabutylammonium bromide, tetrabutylammonium sulfate, tetrabutylammonium methanesulfonate, tetrabutylammonium phosphate, tributylmethylammonium hydroxide, tributylmethylammonium chloride, tributylmethylammonium bromide, tributylmethylammonium sulfate, tributylmethylammonium methanesulfonate, tributylmethylammonium phosphate, benzyltrimethylammonium hydroxide, benzyltrimethylammonium chloride, benzyltrimethylammonium bromide, benzyltrimethylammonium sulfate, benzyltrimethylammonium methanesulfonate, benzyltrimethylammonium phosphate, methyl(trishydroxyethyl)ammonium hydroxide, methyl(trishydroxyethyl)ammonium chloride, methyl(trishydroxyethyl)ammonium bromide, methyl(trishydroxyethyl)ammonium sulfate, methyl(trishydroxyethyl)ammonium methanesulfonate, methyl(trishydroxyethyl)ammonium phosphate, ethyltrimethylammonium hydroxide, ethyltrimethylammonium chloride, ethyltrimethylammonium bromide, ethyltrimethylammonium sulfate, ethyltrimethylammonium methanesulfonate, ethyltrimethylammonium phosphate, methyltriethylammonium hydroxide, methyltriethylammonium chloride, methyltriethylammonium bromide, methyltriethylammonium sulfate, methyltriethylammonium methanesulfonate, methyltriethylammonium phosphate, choline hydroxide, choline chloride, choline bromide, choline sulfate, choline methanesulfonate, choline phosphate, methyl tris (hydroxyethyl)ammonium hydroxide, methyl tris(hydroxyethyl)ammonium chloride, methyl tris(hydroxyethyl)ammonium bromide, methyl tris(hydroxyethyl)ammonium sulfate, methyl tris(hydroxyethyl)ammonium methanesulfonate, methyl tris(hydroxyethyl)ammonium phosphate, salts thereof, and combinations thereof.

17. The method of claim 12, wherein the organic compound comprising a quaternary amine is selected from dimethyldiethylammnonium hydroxide, diallyldimethyl ammonium chloride, betaine, 3-trimethylammoniumpropanesulfonate, tetraethylammonium hydroxide (TEAH), tetrabutylammonium hydroxide (TBAH), choline hydroxide, methyl tris (hydroxyethyl)ammonium hydroxide, salts thereof, and combinations thereof.

18. The method of claim 12, wherein the composition further comprises one or more water-miscible solvents, wherein the water-miscible solvent is selected from triethylene glycol monobutyl ether, propylene glycol n-butyl ether, propylene glycol monobutyl ether, dimethyl sulfoxide, diethylene glycol monophenyl ether, diethylene glycol monobutyl ether, and combinations thereof.

19. The method of claim 12, wherein the composition further comprises an amine compound selected from aminoethylethanolamine, N-methylaminoethanol, aminoethoxyethanol, dimethylaminoethoxyethanol, N-methyldiethanolamine, monoethanolamine (MEA), diethanolamine (DEA), triethanolamine (TEA), 1-amino-2-propanol, 2-amino-1-butanol, isobutanolamine, triethylenediamine, 4-(2-hydroxyethyl)morpholine (HEM), 2-amino-2-(hydroxymethyl)-1,3-propanediol, diglycolamine, diisopropanolamine, tris(hydroxymethyl)aminomethane, and combinations thereof.

20. The method of claim 12, wherein the composition further comprises an amino acid selected from arginine, histidine, lysine, aspartic acid, glutamic acid, serine, threonine, asparagine, glutamine, cysteine, glycine, proline, alanine, valine, isoleucine, leucine, methionine, phenylalanine, tyrosine, tryptophan, salts thereof, and combinations thereof.

21. The method of claim 12, wherein the composition has a pH of about 1 to about 6.

22. The method of claim 12, wherein the microelectronic device substrate comprises a molybdenum layer on the surface thereof.

23. The method of claim 12, wherein the microelectronic device substrate comprises a tungsten layer on the surface thereof.
